(19) United States
(12) Patent Application Publication
(10) Pub. No.: US 2011/0216117 A1
(43) Pub. Date: Sep. 8, 2011

(54) WATER-SOLUBLE AZO COMPOUND OR SALT THEREOF, INK COMPOSITION, AND COLORED MATTER

(75) Inventors: Ryoutarou Morita, Tokyo (JP); Akira Kawaguchi, Tokyo (JP)

(73) Assignee: NIPPON KAYAKU KABUSHIKI KAISHA, TOKYO (JP)

(21) Appl. No.: 13/062,367

(22) PCT Filed: Jun. 12, 2009
(86) PCT No.: PCT/JP2009/060740

§ 371 Date: May 25, 2011

(30) Foreign Application Priority Data
Jun. 19, 2008 (JP) 2008-159850

(51) Int. Cl. B41J 29/38; C09D 11/02; C09B 31/02; B41J 2/175

(52) U.S. Cl. 347/14; 106/31.13; 534/797; 347/85

(57) ABSTRACT

Disclosed is a water-soluble azo compound represented by formula (1) or a salt thereof, which functions as a yellow dye having a high print density suitable for inkjet recording. Matter recorded by using the water-soluble azo compound or a salt thereof has high fastness in various fields, and an ink composition prepared by using the water-soluble azo compound or a salt thereof has excellent storage stability. An ink composition containing the water-soluble azo compound or a salt thereof is also disclosed. In formula (1), R represents a hydrogen atom or the like; n represents an integer of 1-3; m represents 1 or 2; x represents an integer of 2-4; and group A represents a carboxy-substituted C₁-C₂₀ aliphatic amino group, a sulfo-substituted C₁-C₃ aliphatic amino group, a substituted or unsubstituted aromatic amino group, a substituted or unsubstituted aryl C₁-C₄ alkylamino group, or the like.

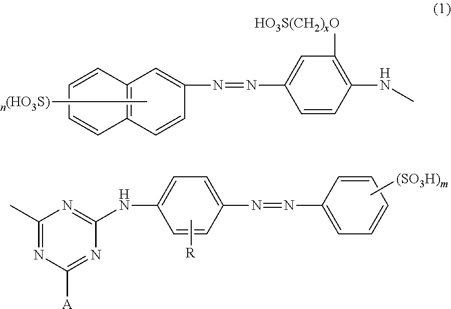

### TECHNICAL FIELD

The present invention relates to a water-soluble azo compound or a salt thereof, an ink composition containing the same, and a colored matter which was colored therewith.

### BACKGROUND ART

For a recording method by an ink jet printer, which is one typical method among a variety of color recording methods, a variety of ink discharge systems have been developed. These systems execute recording by generating ink droplets, which are attached to any of a variety of record-receiving materials (e.g., paper, film, and fabric, etc.). According to this method, a recording head is not brought into direct contact with the record-receiving material; therefore, generation of noise can be avoided thus achieving silent recording. In addition, due to having the feature of reduced size, increased speed and coloring being readily achievable, prevalence in recent years has been in rapid progress, and thus great advancement hereafter is expected.

Inks containing a water-soluble dye dissolved in an aqueous medium have been used as conventional inks for fountain pens, felt pens etc., and inks for ink jet recording. Furthermore, to these inks is generally added a water-soluble organic solvent in order to prevent pen tips or ink discharge nozzles from clogging with the ink. For these inks, demanded are abilities to generate a recorded image with satisfactory density, probability of avoiding occurrence of clogging at the pen tips and nozzles, favorable drying characteristics on the record-receiving materials, suppression of bleeding, superior storage stability, and the like. Additionally, various types of fastness such as water resistance, moisture resistance, light resistance and gas resistance have been required of the recorded image.

Clogging of nozzles of ink jet printers often results from hardening and deposition of a coloring matter when the moisture of the ink evaporates faster than other solvent and additives in the vicinity of the nozzle to cause a state of the composition including less moisture and a substantive amount of the solvent and additives. Therefore, one extremely important expected performance is that solids are less likely to be deposited even when the ink is evaporated to dryness. Moreover, on this ground, high solubility in the solvent and additives is also a property required for coloring matters.

In the meantime, for recording image or character information displayed on a color display of computers in full color by an ink jet printer, subtractive color mixing expressed with four inks having different colors, generally yellow (Y), magenta (M), cyan (C), and black (K) has been employed, whereby the recorded image is presented in full color. In order to reproduce an additive color mixing image formed with red (R), green (G), blue (B) to display on a CRT (cathode ray tube) display and the like as strictly as possible using subtractive color mixing, it is desired that Y, M and C, among the coloring matters used in inks, have a hue approximate to the standard, and are brilliant, respectively. In addition, long term storage stability, as well as high density of the printed image, and superior various types of fastness such as water resistance, moisture resistance, light resistance and gas resistance are also required for the inks. Herein, gas resistance means resistance to a phenomenon of causing discoloration and fading of a printed image via a reaction of a gas present in the air and having an oxidizing action, with a coloring matter (dye) of the recorded image on or in the record-receiving material. Particularly, ozone gas among oxidizing gasses is considered as a main causative substance that promotes the discoloration and fading phenomenon of ink jet recorded image. Since this discoloration and fading phenomenon is characteristic in ink jet images, improvement of the ozone gas resistance is a significant technical problem in the art.

In order to attain photo image qualities, an ink receiving layer may be provided on the surface of an exclusive, ink jet paper which is one of recording papers. A porous white inorganic substance is often used in such an ink receiving layer for facilitating drying of the ink and for minimizing bleeding to provide high quality images. However, discoloration and fading due to ozone gas is markedly observed particularly on such a recording paper. Along with recent prevalence of digital cameras and color printers, the opportunity for printing images with photo image quality obtained by a digital camera or the like have increased also at home. Thus, discoloration and fading of the image due to oxidizing gas in air during storage of the obtained printed matter as described above, as well as ozone gas resistance has been often concerned.

On the other hand, among the aforementioned various types of fastness, water resistance and moisture resistance are recognized as being demanded characteristics which are recognized to be comparatively likely to improve fastness by modifying the record-receiving materials. To the contrary, yellow coloring matters for ink jet recording and yellow inks having high brilliance required for their use, and having satisfactorily sufficient water resistance, moisture resistance and the like have not yet been obtained.

As a well-known yellow coloring matter for ink jet recording that is superior in water solubility and brilliance, C. I. (Color Index) Direct Yellow 132 is exemplified, and a plurality of azo yellow coloring matters having superior fastness properties have been proposed on the basis of development of yellow coloring matters for ink jet recording in recent years. Examples of the azo compound having superior fastness properties are disclosed in Patent Documents 1 to 3. Patent Document 1 discloses a yellow coloring matter reportedly having superior moisture resistance, ozone gas resistance, and light resistance. Patent Document 2 discloses a yellow coloring matter reportedly having superior print density, moisture resistance, nitrogen oxidize gas resistance, ozone gas resistance, and solubility. Patent Document 3 discloses a yellow dye reportedly having high solubility, and superior light resistance, moisture resistance and ozone gas resistance.

Patent Document 1: Japanese Unexamined Patent Application, Publication No. 2006-152244

Patent Document 2: PCT International Publication No. 2008/053776

Patent Document 3: PCT International Publication No. 2004/007618

### DISCLOSURE OF THE INVENTION

### Problems to be Solved by the Invention

An object of the present invention is to provide a water-soluble yellow coloring matter (compound) having high solubility in water, being superior in various fastness properties of the recorded image such as water resistance and moisture resistance, particularly water resistance, and also having well balanced ability to provide high brilliance and print density. Another object of the present invention is to provide an ink composition having favorable storage stability which contains the yellow coloring matter.

### Means for Solving the Problems

In order to solve the foregoing problems, the present inventors thoroughly investigated, and consequently found that a water-soluble disazo compound represented by a certain formula, or a salt thereof, and an ink composition containing the same solve the problems described above. Thus, the present invention was completed.

Accordingly, a first aspect of the present invention provides a water-soluble azo compound represented by the following formula (1) or a salt thereof,

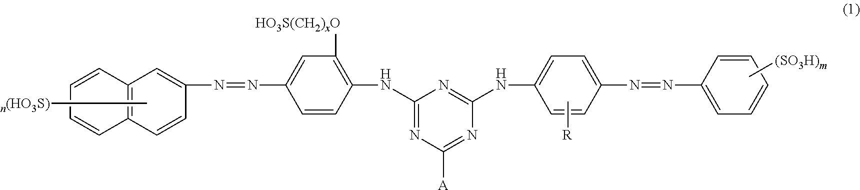

in the formula (1),

R represents a hydrogen atom, a C1-C4 alkyl group, or a C1-C4 alkoxy group;

n represents an integer of 1 to 3, m represents an integer of 1 or 2, and x represents an integer of 2 to 4;

group A represents a substituted or unsubstituted C1-C20 aliphatic amino group, a hydroxy substituted mono- or di-C1-C4 aliphatic amino group, a mono- or di-carboxy substituted C1-C20 aliphatic amino group, a sulfo substituted C1-C3 aliphatic amino group, a substituted or unsubstituted 5- or 6-membered nitrogen-containing heterocyclic group, a substituted or unsubstituted aromatic amino group, or a substituted or unsubstituted aryl C1-C4 alkylamino group.

A second aspect of the invention provides the water-soluble azo compound or a salt thereof according to the first aspect, in which: the water-soluble azo compound represented by the formula (1) or a salt thereof is a water-soluble azo compound represented by the following formula (2) or a salt thereof,

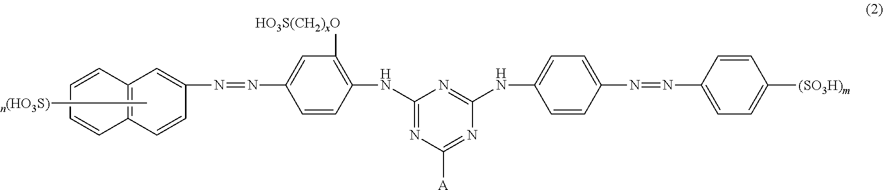

in the formula (2), n, x, and group A are as defined in the formula (1).

A third aspect of the invention provides the water-soluble azo compound or a salt thereof according to the first or second aspect, in which: the group A is selected from the group consisting of amino groups represented by the following formulae (3) to (8),

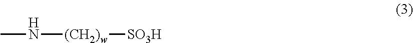

in the formula (3), w represents an integer of 1 to 3;

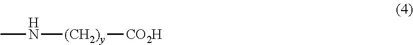

in the formula (4), y represents an integer of 1 to 11;

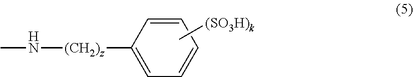

in the formula (5), z represents an integer of from 1 to 3, and k represents an integer of from 0 to 2;

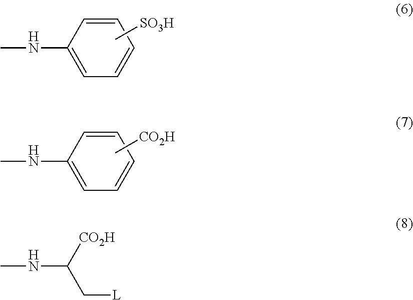

in the formula (8), group L represents a phenyl group or a carboxymethyl group.

A fourth aspect of the invention provides the water-soluble azo compound or a salt thereof according to any one of the first to third aspects, in which: n is 2; x is 3; and the group A is an amino group represented by the formula (7).

A fifth aspect of the invention provides an ink composition containing the water-soluble azo compound or a salt thereof according to any one of the first to fourth aspects as a coloring matter.

A sixth aspect of the invention provides the ink composition according to the fifth aspect further containing a water-soluble organic solvent.

A seventh aspect of the invention provides the ink composition according to the fifth or sixth aspect for use in ink jet recording.

An eighth aspect of the invention provides an ink jet recording method including discharging ink droplets in response to recording signals using the ink composition according to any one of the fifth to seventh aspects as an ink to allow the droplets to adhere onto a record-receiving material thereby executing recording.

A ninth aspect of the invention provides the ink jet recording method according to the eighth aspect, in which the record-receiving material is a communication sheet.

A tenth aspect of the invention provides the ink jet recording method according to the ninth aspect, in which the communication sheet is a sheet having an ink receiving layer containing a porous white inorganic substance.

An eleventh aspect of the invention provides a colored matter which was colored with the water-soluble azo compound or a salt thereof according to any one of the first to fourth aspects, or with the ink composition according to any one of the fifth to seventh aspects.

A twelfth aspect of the invention provides the colored matter according to the eleventh aspect, in which the coloring was carried out with an ink jet printer.

A thirteenth aspect of the invention provides an ink jet printer equipped with a vessel containing the ink composition according to any one of the fifth to seventh aspects.

### EFFECTS OF THE INVENTION

The water-soluble azo compound represented by the above formula (1) or a salt thereof of the present invention is extremely superior in solubility in water. Additionally, the compound is characterized by having favorable filterability on, for example, membrane filters, in the step of producing an ink composition, thereby providing a hue of a very brilliant yellow color with a high brightness and color density on an ink jet recording paper, and is also characterized by being very brilliant as compared with conventional products. Moreover, an ink composition of the present invention containing this compound exhibits extremely favorable storage stability, without solid deposition, physical property alteration, change in the hue and the like after storage for a long period of time. Furthermore, a printed matter obtained using the ink composition of the present invention as an ink for ink jet recording has an ideal hue as a yellow color hue without limitation of usable record-receiving material (for example, paper, film, etc.), and further photographic color images can be strictly reproduced on paper. Additionally, even though recording is carried out on a record-receiving material including a porous white inorganic substance coated on its surface, such as an exclusive ink jet paper for photo image quality and a film, favorable various fastness properties such as moisture resistance, gas resistance and light resistance, particularly water resistance, as well as superior long-term storage stability of photographic recorded image can be achieved. Accordingly, the water-soluble azo compound represented by the formula (1) or a salt thereof is extremely useful as a yellow coloring matter for inks, particularly for inks for ink jet recording.

### PREFERRED MODE FOR CARRYING OUT THE INVENTION

The present invention is explained in detail below. Unless otherwise stated in particular herein, acidic functional groups such as sulfo groups and carboxy groups are represented in the form of their free acids. Also, unless otherwise particularly stated similarly, “the water-soluble azo compound or a salt thereof of the present invention” is expediently referred to as “the water-soluble azo compound of the present invention” to include the compound and salt in order to avoid complexity.

The water-soluble azo compound of the present invention represented by the above formula (1) is a yellow coloring matter that is useful for various types of recording and particularly for ink jet recording. Also, the ink composition of the present invention containing the coloring matter is suited as a yellow ink for ink jet recording.

In the above formula (1), R represents a hydrogen atom, a C1-C4 alkyl group, or a C1-C4 alkoxy group; n represents an integer of 1 to 3, m represents an integer of 1 or 2, and x represents an integer of 2 to 4.

The C1-C4 alkyl group in R may include a straight or branched chain, and preferably has a straight chain. Specific examples of the alkyl group include straight alkyl groups such as methyl, ethyl, n-propyl and n-butyl; and branched alkyl groups such as isopropyl, isobutyl, 1-methylpropyl and t-butyl.

The C1-C4 alkoxy group in R may include a straight or branched chain, and preferably has a straight chain. Specific examples of the alkoxy group include straight alkoxy groups such as methoxy, ethoxy, n-propoxy and n-butoxy; and branched alkoxy groups such as isopropoxy, isobutoxy, 1-methylpropoxy and t-butoxy.

R is preferably a hydrogen atom, methyl, or methoxy, and more preferably a hydrogen atom.

The position of substitution of R is not particularly limited, and provided that the position of substitution of the amino group bound to the triazine ring is position 1, the position of substitution of R is position 2 or position 3; and is preferably, position 3 when R is methyl whereas preferably position 2 when R is methoxy.

In the above formula (1), m represents an integer of 1 or 2, and preferably 1.

Similarly, n represents an integer of 1 to 3, and preferably 2.

Similarly, x represents an integer of 2 to 4, and preferably 3.

In the above formula (1), the group A represents a substituted or unsubstituted C1-C20 aliphatic amino group; a hydroxy substituted mono- or di-C1-C4 aliphatic amino group; a mono- or di-carboxy substituted C1-C20 aliphatic amino group; a sulfo substituted C1-C3 aliphatic amino group; a substituted or unsubstituted 5- or 6-membered nitrogen-containing heterocyclic group; a substituted or unsubstituted aromatic amino group; or a substituted or unsubstituted aryl C1-C4 alkylamino group.

The substituted or unsubstituted C1-C20 aliphatic amino group represented by the group A is exemplified by those having an aliphatic moiety of a straight or branched chain, and those having a straight aliphatic chain are preferred. Although the substituent is not particularly limited, an oxo group, a C1-C4 alkoxy group and the like are preferred. Specific examples include unsubstituted straight aliphatic amino groups such as methylamino, ethylamino, propylamino, butylamino, pentylamino, hexylamino, heptylamino, octylamino, nonylamino, decylamino, undecylamino, dodecylamino, tridecylamino, tetradecylamino, pentadecylamino, hexadecylamino, heptadecylamino, octadecylamino, nonadecylamino, and eicosanylamino; oxo substituted aliphatic amino groups such as n-propionylamino, and isopropionylamino; C1-C4 alkoxy substituted aliphatic amino groups such as methoxyethylamino, and ethoxyethylamino; and the like.

The hydroxy substituted mono- or di-C1-C4 aliphatic amino group represented by the group A is exemplified by those having an aliphatic moiety of a straight or branched chain, and those having a straight aliphatic chain are preferred. Specific examples include hydroxy substituted mono-C1-C4 alkylamino groups such as hydroxyethylamino; hydroxy substituted di-C1-C4 alkylamino groups such as bis-(hydroxyethyl)amino; and the like.

The mono- or di-carboxy substituted C1-C20 aliphatic amino group represented by the group A is exemplified by those having an aliphatic moiety of a straight or branched chain, and those having a straight aliphatic chain are preferred. The aliphatic amino group is preferably a carboxy substituted C1-C20 alkylamino group. The range of the number of carbon atoms is usually 1 to 20, preferably 1 to 18, more preferably 1 to 14, and still more preferably 1 to 12. Specific examples include mono-carboxy substituted C1-C20 monoalkylamino groups such as carboxymethylamino, carboxyethylamino, carboxypropylamino, carboxy-n-butylamino, carboxy-n-pentylamino, carboxy-n-hexylamino, carboxy-n-heptylamino, carboxy-n-octylamino, carboxy-n-nonylamino, carboxy-n-decanylamino, carboxy-n-undecanylamino, carboxy-n-dodecanylamino, carboxy-n-tridecanylamino, carboxy-n-tetradecanylamino, carboxy-n-pentadecanylamino, carboxy-n-hexadecanylamino, carboxy-n-heptadecanylamino, carboxy-n-octadecanylamino, carboxy-n-nonadecanylamino, and carboxy-n-eicosanylamino; mono-carboxy substituted C1-C20 dialkylamino groups such as bis-(carboxymethyl)amino, bis-(carboxyethyl)amino, and bis-(carboxypropyl)amino; di-carboxy substituted C1-C20 alkylamino groups such as 1,2-dicarboxyethyl-1-amino, and 1,3-dicarboxypropyl-1-amino; and the like.

The sulfo substituted C1-C3 aliphatic amino group represented by the group A is exemplified by those having an aliphatic moiety of a straight or branched chain, and those having a straight aliphatic chain are preferred. Specific examples include sulfomethylamino, sulfoethylamino, sulfopropylamino and the like, and sulfoethylamino is preferred.

The substituted or unsubstituted 5- or 6-membered nitrogen-containing heterocyclic group represented by the group A is exemplified by nitrogen-containing heterocyclic groups having 0 or 1 oxygen atom. Specific examples include pyrrolidinyl, piperidinyl, morpholinyl and the like, preferably piperidinyl or morpholinyl, and more preferably morpholinyl. These may have a substituent, but unsubstituted ones are preferred.

The substituted or unsubstituted aromatic amino group represented by the group A is exemplified by a substituted or unsubstituted phenylamino group or naphthylamino group, and the former group is preferred. The substituent of the aromatic amino group is not particularly limited, and may be exemplified by 1 or 2 substituent(s) selected from the group consisting of sulfo, carboxy, C1-C4 alkoxy and hydroxy, and sulfo or carboxy is preferred. Also, the number of the substituent is preferably 1. Specific examples include unsubstituted phenylamino; sulfo substituted aromatic amino groups such as 2-, 3-, or 4-sulfophenylamino; carboxy substituted aromatic amino groups such as 2-, 3-, or 4-carboxyphenylamino, 3,5-biscarboxyphenylamino; alkoxy substituted aromatic amino groups such as 3- or 4-methoxyphenylamino; hydroxy substituted aromatic amino groups such as 2-, 3-, or 4-hydroxyphenylamino; carboxy and hydroxy substituted aromatic amino groups such as 3-carboxy-4-hydroxyphenylamino; carboxy and sulfo substituted aromatic amino groups such as 2-carboxy-4-sulfophenylamino; and the like.

The position of substitution of the substituent is not particularly limited, and when the group A is a substituted phenylamine group, provided that the position of substitution of the amino group is position 1, position of substitution of the substituent is preferably position 3 or 4, and more preferably position 3.

When the group A is a substituted naphthylamino group, the position of substitution of the amino group is preferably position 2, in other words, a 2-aminonaphthyl group is preferred. In addition, when the naphthylamino group has a substituent, the number of the substituent is preferably 2, and the position of substitution thereof is preferably position 4 and position 8; or position 6 and position 8.

The substituted or unsubstituted aryl C1-C4 alkylamino group represented by the group A is exemplified by a substituted or unsubstituted phenyl C1-C4 alkylamino group, or a substituted or unsubstituted naphthyl C1-C4 alkylamino group, and the former is preferred. The type and the number of the substituent are not particularly limited, and sulfo or carboxy is preferred, whereas the number of the substituent is 1 or 2, and preferably 1. Also the position of substitution of these substituents is not particularly limited; however, it is preferred that sulfo is substituted on aryl, and that carboxy is substituted on alkyl. Specific examples include unsubstituted aryl C1-C₄ alkylamino groups such as benzylamino, and phenethylamino; sulfa substituted aryl C1-C4 alkylamino groups such as (4-sulfophenyl)methylamino, (4-sulfophenyl)ethylamino, and (2,4-disulfophenyl)ethylamino; carboxy substituted aryl C₁-C₄ alkylamino groups such as 1-carboxy-(2-phenyl)ethyl-1-amino; and the like.

The group A is preferably a mono- or di-carboxy substituted C1-C20 aliphatic amino group; a sulfa substituted C1-C3 aliphatic amino group; an unsubstituted 5- or 6-membered nitrogen-containing heterocyclic group; a sulfa or carboxy substituted aromatic amino group; or a sulfo or carboxy substituted phenyl C1-C4 alkylamino group. Sulfo or carboxy substituted aromatic amino groups are more preferred, and carboxy substituted aromatic amino groups are still more preferred. Specific examples and the like thereof are as in the foregoing.

In the formula (1), the position of substitution of the sulfa group represented by —(SO₃H)ₙ is not particularly limited, and provided that the position of substitution of the azo group is position 2, the sulfo group is preferably substituted at: position 6 when n is 1; position 4 and position 8, position 5 and position 7, or position 6 and position 8 when n is 2; position 4, position 6, and position 8 when n is 3, respectively.

In the formula (1), the position of substitution of the sulfo group represented by —(SO₃H)ₘ is not particularly limited, and provided that the position of substitution of the azo group is position 2, the sulfo group is preferably substituted at: position 2, position 3, or position 4, preferably position 4 when m is 1; position 2 and position 4, or position 2 and position 5 when m is 2; respectively.

Among the compounds represented by the above formula (1), preferred are compounds represented by the above formula (2).

In the above formula (2), n, x, and the group A are as defined in connection with the above formula (1), and specific examples and the like of the same may be similar to those in connection with the above formula (1) including preferable options.

More preferable compounds represented by the above formulae (1) and (2) are compounds in which the group A is a group selected from the group consisting of amino groups represented by the above formulae (3) to (8).

In the above formula (3), w represents an integer of 1 to 3, and preferably 2.

In the above formula (4), y represents an integer of 1 to 11, and preferably an integer of 5 to 11.

In the above formula (5), k represents an integer of 0 to 2, and preferably 1, whereas z represents an integer of 1 to 3, and preferably 1. When k in the formula (5) is other than 0, in other words, when a sulfo group is included without specifying its position of substitution, the position of substitution of the sulfo group is not particularly limited, but provided that the position of substitution of the alkylene group is position 1, the position of substitution of the sulfo group is preferably position 2 and/or position 4, and more preferably position 4.

In the above formula (6), the position of substitution of the sulfo group presented without specifying the position of substitution is not particularly limited, but provided that the position of substitution of the amino group is position 1, the position of substitution of the sulfo group is preferably position 3.

In the above formula (7), the position of substitution of the carboxy group presented without specifying the position of substitution is not particularly limited, but provided that the position of substitution of the amino group is position 1, the position of substitution of the sulfo group is preferably position 3.

In the above formula (8), the group L represents phenyl or carboxymethyl, and preferably phenyl.

With respect to R, n, m, x, the group A, w, y, z, k, and the group L, positions of substitution of the same, and the like in the above formulae (1) to (8), those in which preferable options are combined are more preferred, and those in which more preferable options are combined are still more preferred. In addition, compounds in which still more preferable options are combined are similarly even more preferred.

The compound represented by the above formula (1) is present in the form of either a free acid or a salt thereof. The salt of the compound represented by the above formula (1) may be a salt with an inorganic or organic cation. Specific examples of the inorganic cation salt include alkali metal salts, for example, salts with lithium, sodium, potassium or the like. Furthermore, specific examples of the organic cation salt include, for example, quaternary ammonium salts represented by the following formula (9) but not limited thereto.

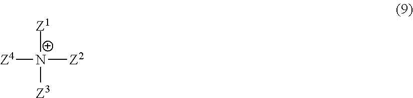

In the formula (9), Z¹ to Z⁴ each independently represent a hydrogen atom, a C1-C4 alkyl group, a hydroxy(C1-C4)alkyl group, or a hydroxy(C1-C4)alkoxy(C1-C4)alkyl group.

Wherein, examples of the alkyl group in Z¹ to Z⁴ include methyl, ethyl and the like; examples of the hydroxyalkyl group include hydroxymethyl, hydroxyethyl, 3-hydroxypropyl, 2-hydroxypropyl, 4-hydroxybutyl, 3-hydroxybutyl, 2-hydroxybutyl and the like; and further, examples of the hydroxyalkoxyalkyl group include hydroxyethoxymethyl, 2-hydroxyethoxyethyl, 3-(hydroxyethoxy)propyl, 3-(hydroxyethoxy)butyl, 2-(hydroxyethoxy)butyl and the like.

Among the aforementioned salts, preferable salts include sodium, potassium, lithium, monoethanolamine, diethanolamine, triethanolamine, monoisopropanolamine, diisopropanolamine and triisopropanolamine salts, ammonium salts, and the like. Of these, particularly preferred are lithium, sodium, and ammonium salts.

The water-soluble azo compound of the present invention represented by the above formula (1) can be produced, for example, as in the following. It is to be noted that R, m, n, x, and the group A used suitably in the following formulae (AA) to (I) mean similarly to the definitions in the above formula (1), respectively.

The compound represented by the following formula (AA) obtained with reference to examples described in the specification of Japanese Unexamined Patent Application Publication No. 2004-75719 is converted into a methyl-ω-sulfonic acid derivative (B) using sodium bisulfite and formalin. Next, an aminonaphthalenesulfonic acid represented by the following formula (C) is diazotized by a routine method, and the product is subjected to a coupling reaction at 0 to 15° C. and a pH of 2 to 4 with the methyl-w-sulfonic acid derivative represented by the formula (B) obtained above, and subsequently subjected to a hydrolyzing reaction at 80 to 95° C. and a pH of 10.5 to 11.5 to obtain a compound represented by the following formula (D).

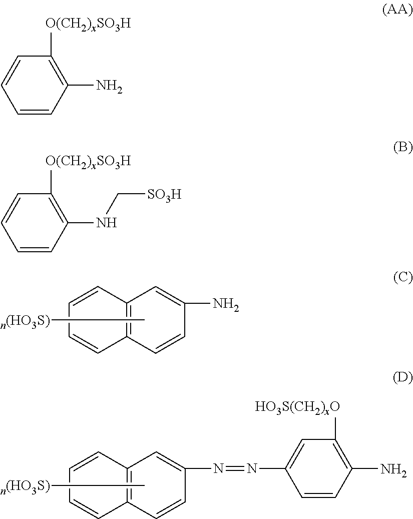

On the other hand, a compound represented by the following formula (G) is obtained by carrying out a reaction with a similar method to the aforementioned method except that a compound represented by the following formula (E) is used in place of the compound represented by the above formula (AA), and that a compound represented by the following formula (F) is used in place of the compound represented by the above formula (C).

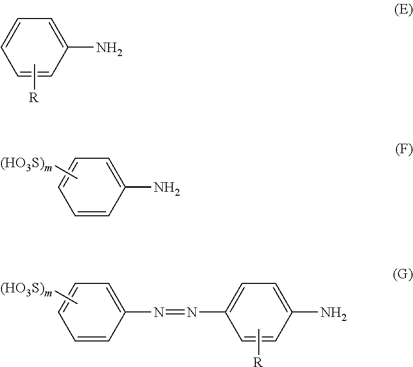

One equivalent of the resulting compound represented by the above formula (G) is condensed with cyanuric halide, for example, 1 equivalent of cyanuric chloride under a weakly acidic condition (usually a pH of 5 to 6) at a temperature of 0 to 15° C. to obtain a compound represented by the following formula (H). One equivalent of the obtained compound represented by the formula (H) is condensed with one equivalent of the compound represented by the above formula (D) under a weakly acidic condition (usually a pH of 6 to 7) at a temperature of 20 to 35° C. to obtain a compound represented by the following formula (1).

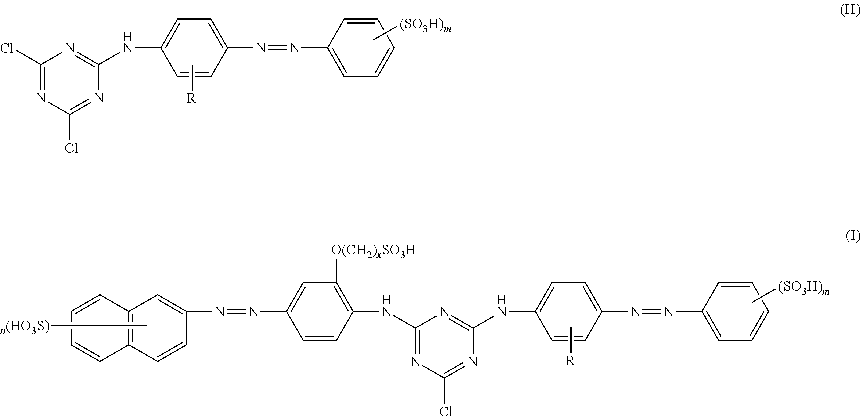

The water-soluble azo compound of the present invention represented by the above formula (1) can be obtained by substituting a chlorine atom in the obtained compound represented by the above formula (1) with an amine corresponding to the group A represented by “A-H” preferably under a condition of a temperature of 80 to 95° C. and a pH of 7 to 9.

Specific examples of the compound represented by the above formula (AA) include 2-(sulfoethoxy)aniline, 2-(sulfopropoxy)aniline, 2-(sulfobutoxy)aniline and the like, whereas specific examples of the compound represented by the above formula (C) include 2-aminonaphthalene-4,8-disulfonic acid, 2-aminonaphthalene-5,7-disulfonic acid, 2-aminonaphthalene-6,8-disulfonic acid, 2-aminonaphthalene-4,6,8-trisulfonic acid, and the like.

In addition, specific examples of the compound represented by the above formula (E) include aniline, 3-methylaniline, 2-methylaniline, 2-methoxyaniline, 3-methoxyaniline and the like, whereas specific examples of the compound represented by the above formula (F) include 4-aminobenzenesulfonic acid, 3-aminobenzenesulfonic acid, 2-aminobenzenesulfonic acid, 2-aminobenzene-1,4-disulfonic acid, 4-aminobenzene-1,3-disulfonic acid and the like.

Of these compounds, for example, the compound represented by the formula (AA) can be synthesized by a routine method, and any of the compounds represented by the formulae (C), (E) and (F) can be obtained as a commercially available product.

Next, specific examples of preferable water-soluble azo compound of the present invention represented by the above formula (1) are shown in Table 1 below. In Table 1, the acidic functional group such as a sulfo group is represented in the form of its free acid.

TABLE 1

| Compound | |
|---|---|
| Number | Structural Formula |
| 1 | 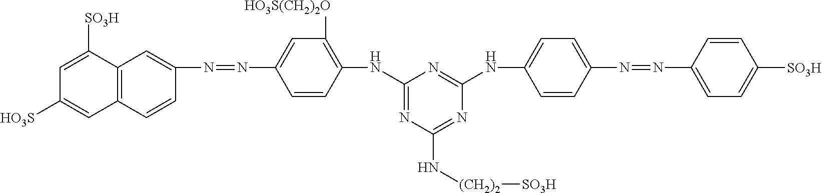 |
| 2 | 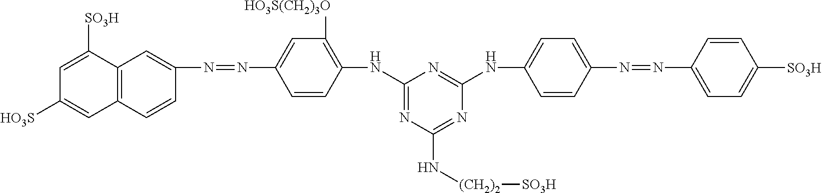 |
| 3 | 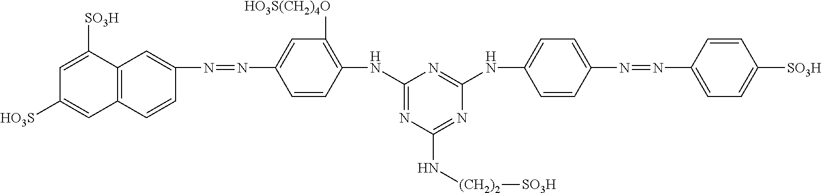 |
| 4 | 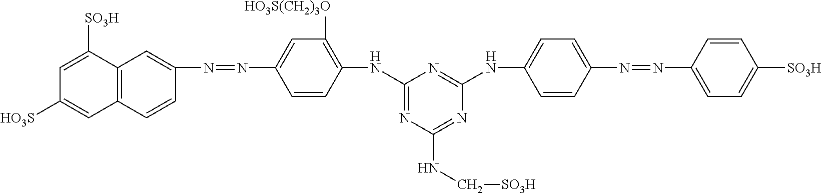 |
| 5 | 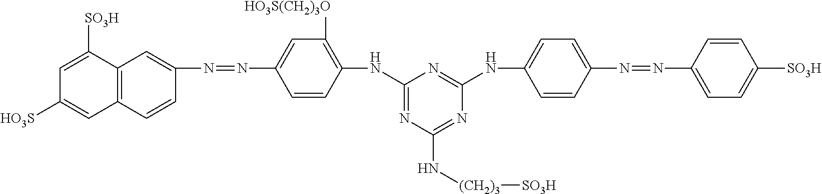 |
| 6 | 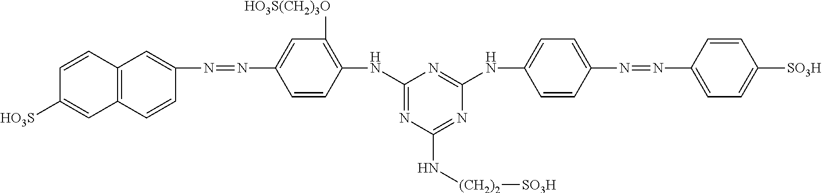 |
| 7 | 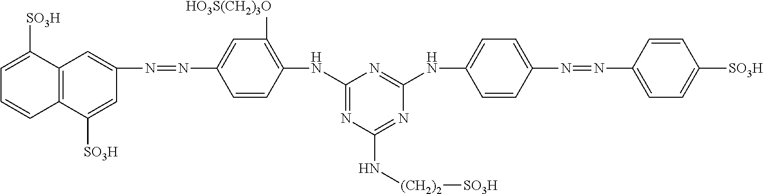 |
| 8 | 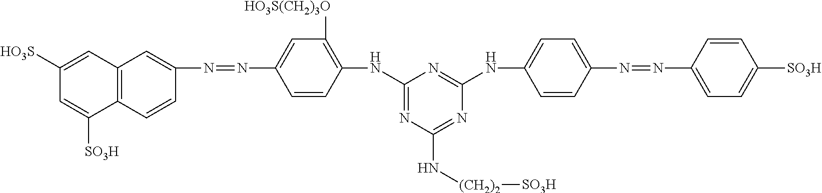 |
| 9 | 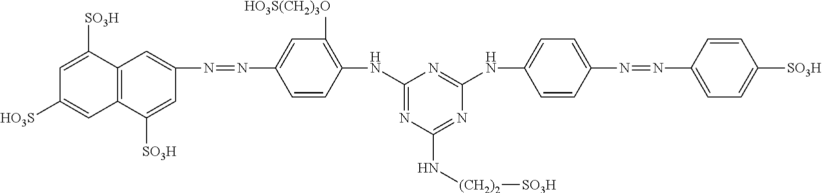 |
| 10 | 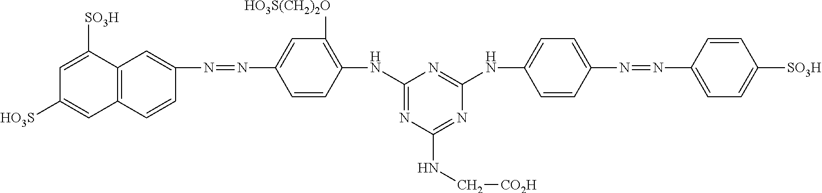 |
| 11 | 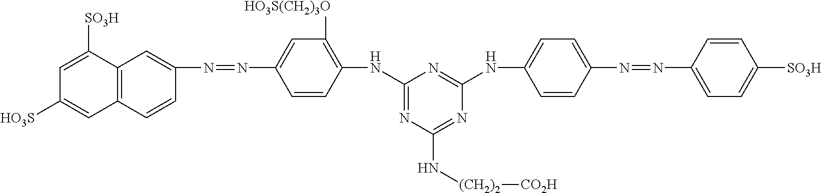 |
| 12 | 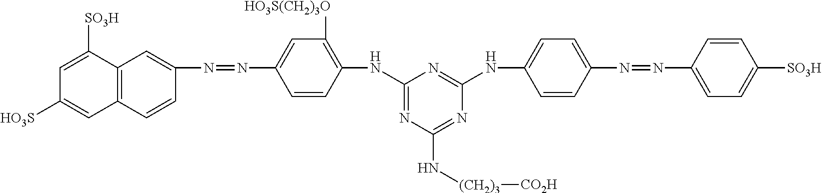 |
| 13 | 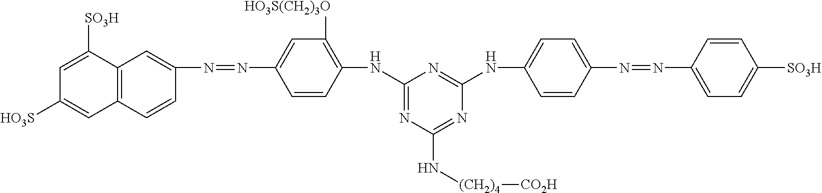 |
| 14 | 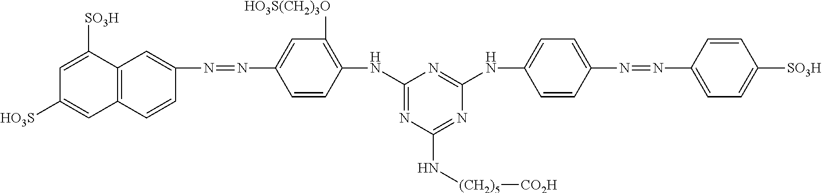 |
| 15 | 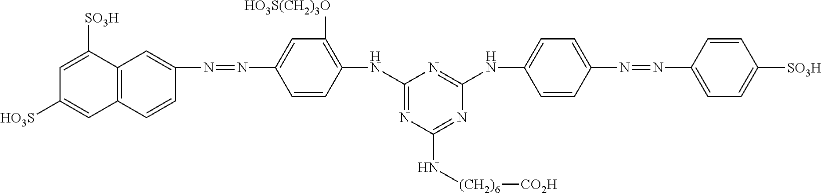 |
| 16 | 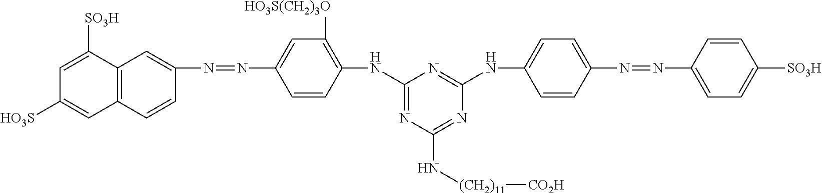 |
| 17 | 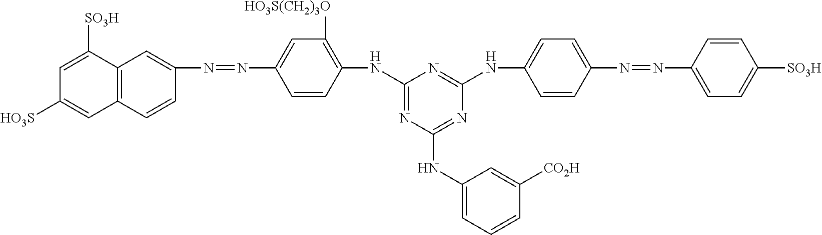 |
| 18 | 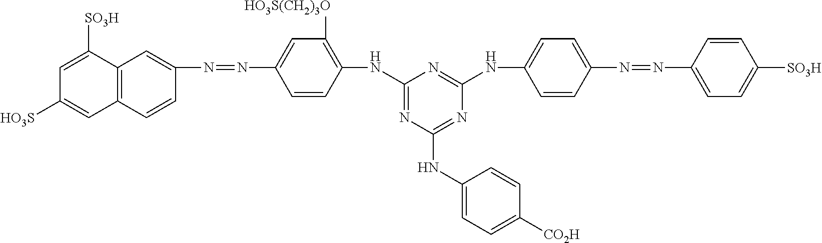 |
| 19 | 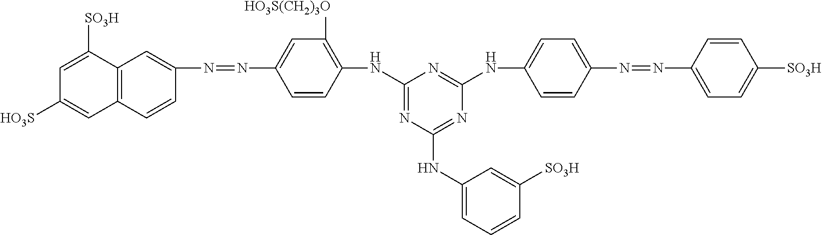 |
| 20 | 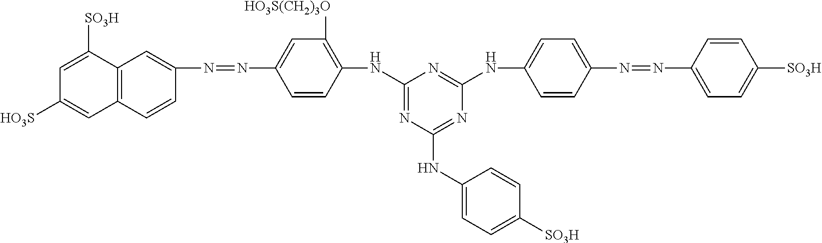 |
| 21 | 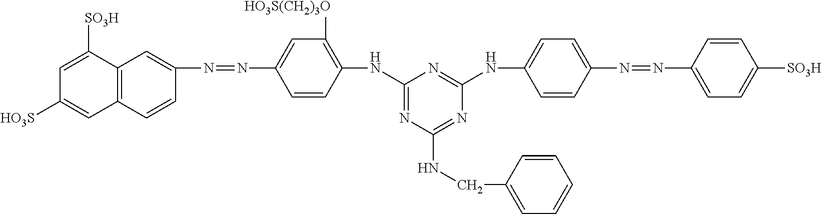 |
| 22 | 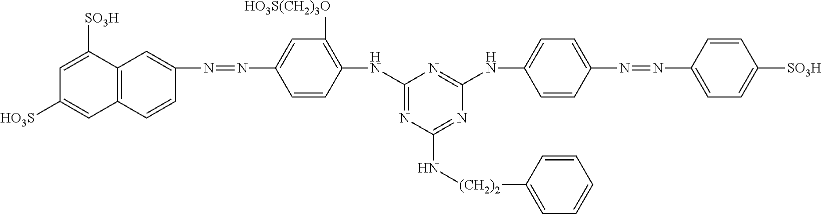 |
| 23 | 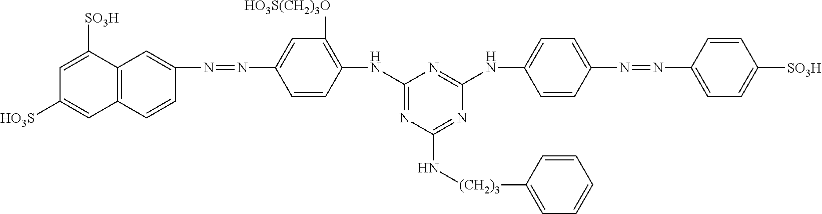 |
| 24 | 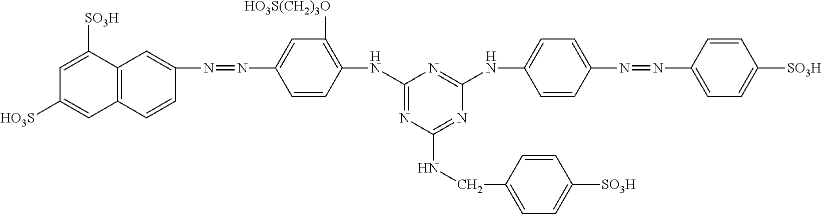 |
| 25 | 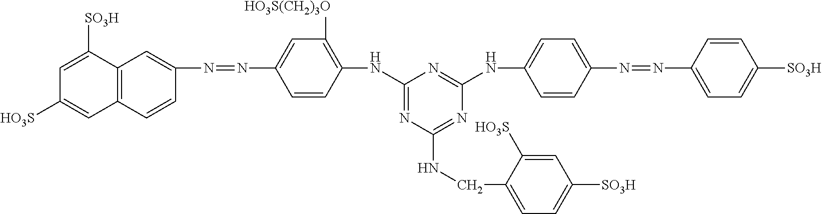 |
| 26 | 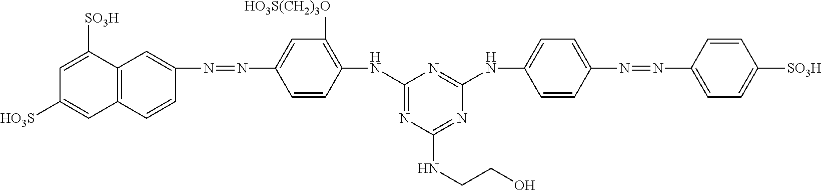 |
| 27 | 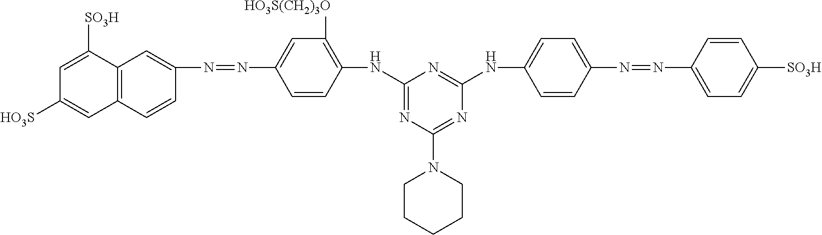 |
| 28 | 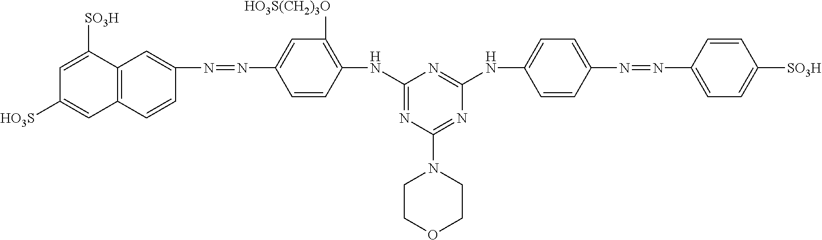 |
| 29 | 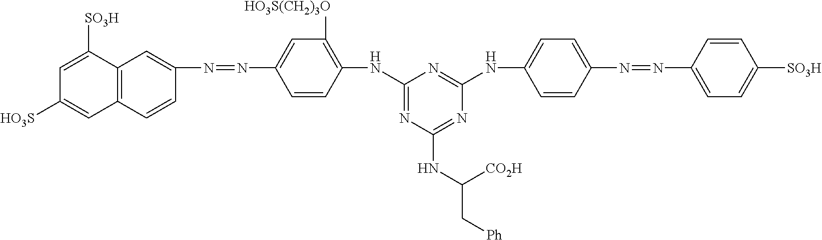 |
| 30 | 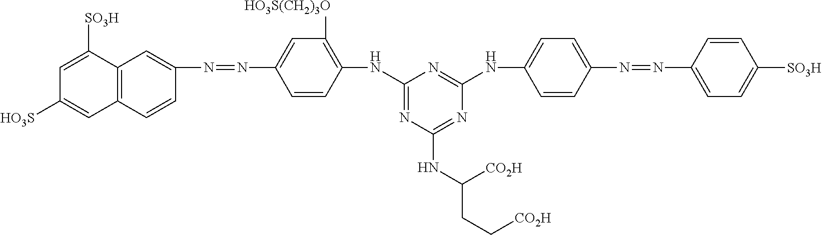 |
| 31 | 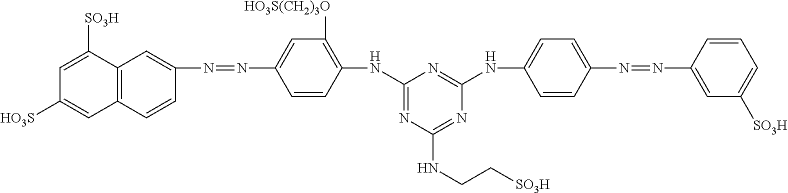 |
| 32 | 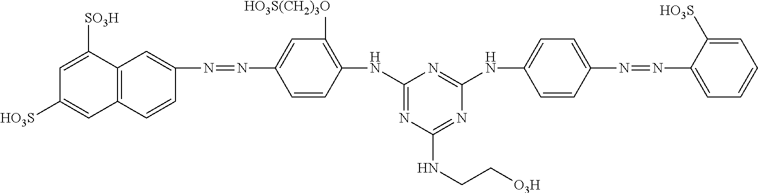 |
| 33 | 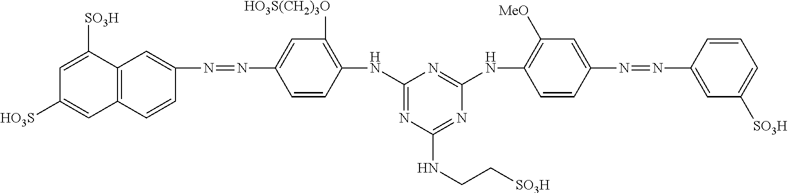 |
| 34 | 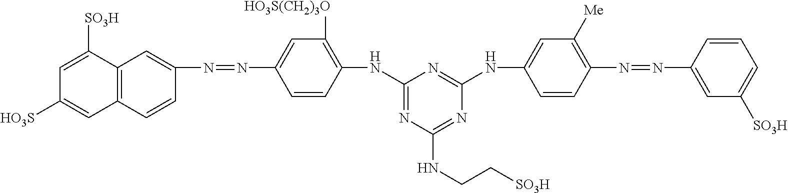 |
| 35 | 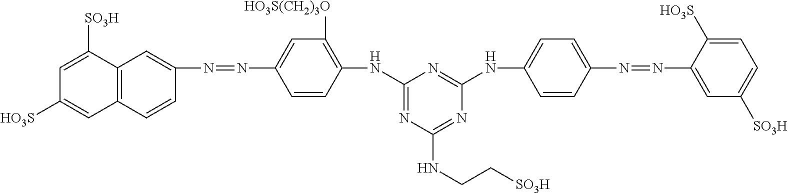 |
| 36 | 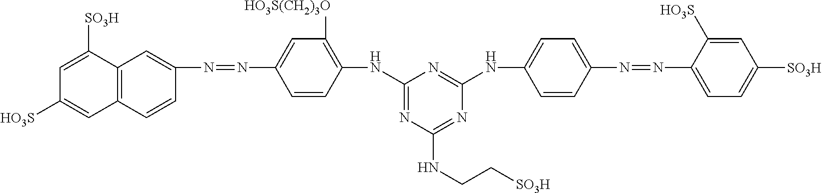 |
| 37 | 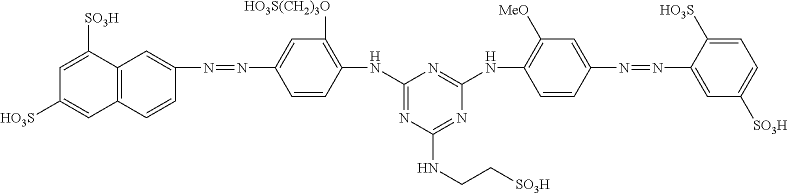 |
| 38 | 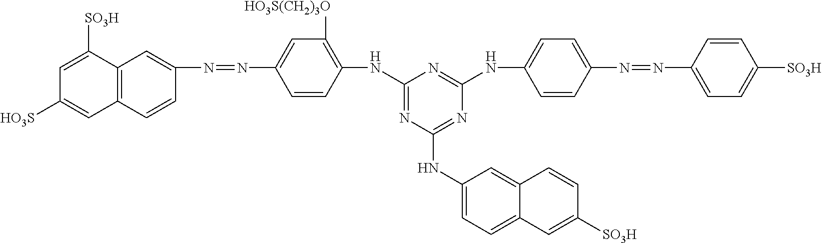 |
| 39 | 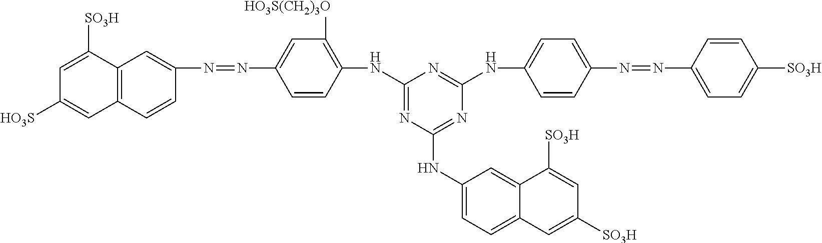 |
| 40 | 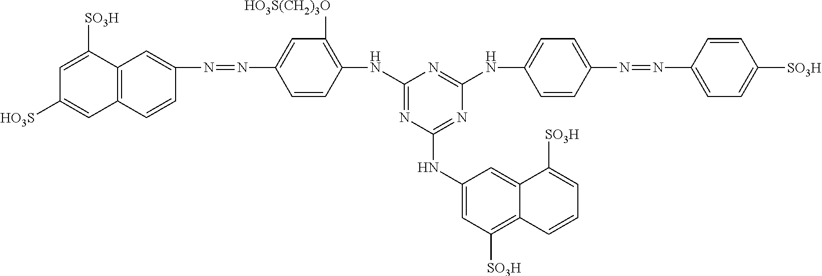 |

As would be apparent to persons skilled in the art, salts of the compound represented by the above formula (1) can be easily obtained with the following method and the like.

A sodium salt of the compound represented by the above formula (1) can be obtained as a wet cake by, for example, adding sodium chloride to a reaction liquid after completing the reaction in the final step of the synthesis reaction of the compound represented by the above formula (1), or to a wet cake containing the compound represented by the formula (1) or an aqueous solution prepared by dissolving a dried matter of the compound represented by the formula (1), thereby permitting salting-out, and then collecting the deposited solid by filtration.

Also, after thus obtained wet cake of the sodium salt is dissolved in water, the pH of the solution is adjusted appropriately by adding an acid such as hydrochloric acid, and the deposited solid is collected by filtration. Inorganic salts such as e.g., sodium chloride and sodium sulfate contained as impurities can be removed by washing the obtained solid with water or acidic water such as aqueous hydrochloric acid, or the like, whereby a free acid of the compound represented by the above formula (1), or a mixture containing a sodium salt and a free acid of the compound represented by the formula (1), i.e., the compound converted into a sodium salt in part, can be also obtained.

Also, when for example, an inorganic base such as potassium hydroxide, lithium hydroxide or aqueous ammonia, or an organic base such as a hydroxide of the compound represented by the above formula (9) is added to a wet cake of a free acid of the compound represented by the formula (1) while stirring with water to make alkaline, each corresponding potassium salt, lithium salt, ammonium salt, or quaternary ammonium salt may be obtained. By regulating the number of moles of the aforementioned salt added with respect to the number of moles of the free acid, preparation of, for example, mixed salts of lithium and sodium, etc., alternatively, mixed salts of lithium, sodium and ammonium, etc. is also enabled.

As the inorganic base, in addition to hydroxides of an alkali metal such as lithium hydroxide, sodium hydroxide and potassium hydroxide described above, carbonates of an alkali metal such as lithium carbonate, sodium carbonate and potassium carbonate, as well as ammonium hydroxide (aqueous ammonia), and the like may be used.

As the organic base, for example, salts of a quaternary ammonium represented by the above formula (9), e.g., salts of alkanolamine such as diethanolamine or triethanolamine, and the like may be used, but not limited thereto.

The salt of the compound represented by the above formula (1) may have varying physical properties such as solubility, or performances of the inks when used as an ink, depending on the type of the salt thereof. Therefore, it is also preferred to select the type of the salt to meet intended performances of the ink, and the like.

The water-soluble azo compound of the present invention is suited for staining of natural and synthetic fiber materials or blended fabric products, and for production of writing inks, particularly inks for ink jet recording.

The reaction liquid containing the water-soluble azo compound of the present invention (for example, a reaction liquid after completing the reaction in the final step described above, etc.) may be also used directly for producing an ink composition of the present invention. Alternatively, after isolating the compound from the reaction liquid by, for example, crystallization, spray drying or the like, followed by drying as needed, the resulting compound can be used to prepare an ink composition. The ink composition of the present invention contains the water-soluble azo compound of the present invention as a coloring matter in an amount of usually 0.1 to 20% by mass, more preferably 1 to 10% by mass, and still more preferably 2 to 8% by mass in the total mass of the ink composition.

The ink composition of the present invention is prepared by dissolving the compound represented by the above formula (1) in an aqueous medium such as water or a mixed solvent of water and a water-soluble organic solvent (organic solvent that is miscible with water), and adding thereto an ink preparation agent as needed. When the ink composition is used as an ink for ink jet printer, the content of inorganic matter such as metal cation chlorides (for example, sodium chloride etc.) and sulfuric acid salts (for example, sodium sulfate etc.) contained as impurities is preferably as low as possible. In this regard, the total content of, for example, sodium chloride and sodium sulfate accounts for about no greater than 1% by mass in total mass of the water-soluble azo compound of the present invention, and the lower limit may be no greater than the detection limit of the analytical instrument, i.e., may be 0% by mass. For the production of the compound including less inorganic impurities, for example, a desalination treatment may be carried out with a method with a reverse osmotic membrane well-known per se. The desalination treatment can be also executed by other method in which a dried matter or wet cake of the compound or a salt thereof of the present invention is stirred in a mixed solvent of an alcohol such as methanol and water to give a suspension, and the solid is collected by filtration followed by drying.

The ink composition of the present invention is prepared with water as a medium, and may contain a water-soluble organic solvent as needed in the range not to deteriorate the effects of the present invention. The water-soluble organic solvent may also have a function as a dye solubilizer, a drying-preventive agent (wetting agent), a viscosity adjusting agent, a permeation accelerating agent, a surface tension adjusting agent, a defoaming agent and the like, and it is preferred that the water-soluble organic solvent is contained in the ink composition of the present invention. The other ink preparation agent includes well-known additives such as, for example, a preservative and fungicide, a pH adjusting agent, a chelating reagent, a rust-preventive agent, an ultraviolet ray absorbing agent, a viscosity adjusting agent, a dye solubilizer, a discoloration-preventive agent, an emulsification stabilizer, a surface tension adjusting agent, a defoaming agent, a dispersant, and a dispersion stabilizer. The content of the water-soluble organic solvent is 0 to 60% by mass, and preferably 10 to 50% by mass of the entire ink, whereas the ink preparation agent may be used in an amount of 0 to 20% by mass, and preferably 0 to 15% by mass of the entire ink. The remaining component is water.

The water-soluble organic solvent usable in the present invention may be, for example: a (C1-C4)alkanol such as methanol, ethanol, n-propanol, isopropanol, n-butanol, isobutanol, secondary butanol and tertiary butanol; an amide such as N,N-dimethylformamide and N,N-dimethylacetamide; heterocyclic ketone such as 2-pyrrolidone, N-methyl-2-pyrrolidone, 1,3-dimethylimidazolidin-2-one and 1,3-dimethylhexahydropyrimid-2-one; ketone or a keto alcohol such as acetone, methylethylketone and 2-methyl-2-hydroxypentan-4-one; a cyclic ether such as tetrahydrofuran and dioxane; a mono-, oligo-, or poly-alkylene glycol or thioglycol having a (C2-C6)alkylene unit such as ethylene glycol, 1,2- or 1,3-propylene glycol, 1,2- or 1,4-butylene glycol, 1,6-hexylene glycol, diethylene glycol, triethylene glycol, tetraethylene glycol, dipropylene glycol, polyethylene glycol, polypropylene glycol and thiodiglycol; polyol (triol) such as glycerin and hexane-1,2,6-triol; (C1-C4)monoalkyl ether of a polyhydric alcohol such as ethylene glycol monomethyl ether, ethylene glycol monoethyl ether, diethylene glycol monomethyl ether, diethylene glycol monoethyl ether, diethylene glycol monobutyl ether (butylcarbitol), triethylene glycol monomethyl ether and triethylene glycol monoethyl ether; γ-butyrolactone, dimethyl sulfoxide, and the like.

As the water-soluble organic solvent, preferable examples include isopropanol, glycerin, mono-, di-, or tri-ethylene glycol, dipropylene glycol, 2-pyrrolidone, N-methyl-2-pyrrolidone, and butylcarbitol, whereas more preferable examples include isopropanol, glycerin, diethylene glycol, 2-pyrrolidone, N-methyl-2-pyrrolidone, and butylcarbitol. These water-soluble organic solvents are used either alone or as a mixture.

The preservative and fungicide may include, for example, a compound of organic sulfur based, organic nitrogen sulfur based, organic halogen based, haloallyl sulfone based, iodopropargyl based, N-haloalkylthio based, benzothiazole based, nitrile based, pyridine based, 8-oxyquinoline based, isothiazoline based, dithiol based, pyridineoxide based, nitropropane based, organic tin based, phenol based, quaternary ammonium salt based, triazine based, thiadiazine based, anilide based, adamantane based, dithiocarbamate based, brominated indanone based, benzylbromoacetate based, or the like.

The organic halogen based compound may include, for example, sodium pentachlorophenol; the pyridineoxide based compound may include, for example, sodium 2-pyridinethiol-1-oxide; and the isothiazoline based compound may include, for example, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesiumchloride, 5-chloro-2-methyl-4-isothiazolin-3-one calciumchloride, 2-methyl-4-isothiazolin-3-one calciumchloride, and the like.

The other preservative and fungicide may be sodium acetate, sodium sorbate, sodium benzoate, and the like. In addition, another specific examples of preferable preservative and fungicide include e.g., trade names Proxel GXL (S), Proxel XL-2 (S) manufactured by Avecia Limited, and the like.

The pH adjusting agent may be used for the purpose of improving storage stability of the ink, and an arbitrary substance can be used as long as the pH of the ink can be controlled to fall within the range of 6.0 to 11.0. Examples of the pH adjusting agent include alkanolamines such as diethanolamine and triethanolamine, hydroxides of an alkali metal such as lithium hydroxide, sodium hydroxide and potassium hydroxide, ammonium hydroxide (aqueous ammonia) as well as carbonates of an alkali metal such as lithium carbonate, sodium carbonate and potassium carbonate, and the like.

The chelating agent may include, for example, disodium ethylenediamine tetraacetate, sodium nitrilo triacetate, sodium hydroxyethylethylenediamine triacetate, sodium diethylenetriamine pentaacetate, sodium uracil diacetate, and the like.

The rust-preventive agent may include, for example, acidic sulfite, sodium thiosulfate, ammonium thioglycolate, diisopropylammonium nitrite, pentaerythritol tetranitrate, dicyclohexylammonium nitrite, and the like.

Examples of the ultraviolet ray absorbing agent include benzophenone based compounds, benzotriazole based compounds, cinnamic acid based compounds, triazine based compounds, stilbene based compounds, and the like. In addition, a fluorescent whitening agent generally referred to, which is a compound that absorbs an ultraviolet ray to emit fluorescence, and which is typified by a benzoxazole based compound may be also used.

The viscosity adjusting agent may include a water-soluble polymer compound, and specific examples include polyvinyl alcohols, cellulose derivatives, polyamine, polyimine, and the like.

The dye solubilizer may include, for example, urea, ε-caprolactam, ethylene carbonate, and the like. It is preferred to use urea.

The discoloration-preventive agent is used for the purpose of improving storability of the image. As the discoloration-preventive agent, a variety of organic and metal complex based discoloration-preventive agents may be used. Examples of the organic discoloration-preventive agent include hydroquinones, alkoxyphenols, dialkoxyphenols, phenols, anilines, amines, indanes, chromanes, alkoxyanilines, heterocycles and the like, whereas examples of the metal complex include nickel complexes, zinc complexes and the like.

As the surface tension adjusting agent, surfactants may be exemplified, and examples include anionic surfactants, amphoteric surfactants, cationic surfactants, nonionic surfactants, and the like.

Examples of the anionic surfactant include alkylsulfocarboxylic acid salts, α-olefinsulfonic acid salts, polyoxyethylenealkyl ether acetic acid salts, N-acylamino acid and salts thereof, N-acylmethyltaurine salts, alkylsulfate polyoxyalkyl ether sulfuric acid salts, alkylsulfate polyoxyethylenealkyl ether phosphoric acid salts, rosin acid soap, castor oil sulfate ester salts, lauryl alcohol sulfate ester salts, alkylphenolic phosphate esters, alkylated phosphate esters, alkylarylsulfonic acid salts, diethyl sulfosuccinic acid salts, diethylhexyl sulfosuccinic acid salts, dioctyl sulfosuccinic acid salts, and the like.

Examples of the cationic surfactant include 2-vinylpyridine derivatives, poly(4-vinylpyridine) derivatives, and the like.

Examples of the amphoteric surfactant include lauryldimethylamino acetate betaine, 2-alkyl-N-carboxymethyl-N-hydroxyethylimidazolinium betaine, coconut oil fatty acid amide propyldimethylamino acetate betaine, polyoctylpolyaminoethylglycine, imidazoline derivatives, and the like.

Examples of the nonionic surfactant include: ether based surfactants such as polyoxyethylene nonylphenyl ether, polyoxyethylene octylphenyl ether, polyoxyethylene dodecyl phenyl ether, polyoxyethylene oleyl ether, polyoxyethylene lauryl ether and polyoxyethylene alkyl ether; ester based surfactants such as polyoxyethylene oleate esters, polyoxyethylene distearate esters, sorbitan laurate, sorbitan monostearate, sorbitan monooleate, sorbitan sesquioleate, polyoxyethylene monooleate and polyoxyethylene stearate; acetylene alcohol based surfactants such as 2,4,7,9-tetramethyl-5-decyne-4,7-diol, 3,6-dimethyl-4-octyne-3,6-diol and 3,5-dimethyl-1-hexyn-3-ol; and other specific examples include trade names Surfynol 104, 82, 465, Olfin STG manufactured by Nissin Chemical Co., Ltd., and the like.

As the defoaming agent, a highly oxidized oil based compound, glycerin fatty acid ester based compound, fluorine based compound, silicone based compound or the like may be used as needed.

These ink preparation agents may be used either alone or as a mixture. The surface tension of the ink composition of the present invention is usually 25 to 70 mN/m, and more preferably 25 to 60 mN/m. In addition, the viscosity of the ink composition of the present invention is adjusted to preferably no greater than 30 mPa·s, and more preferably no greater than 20 mPa·s.

In production of the ink composition of the present invention, the order of dissolving each reagent such as additives is not particularly limited. When the composition is prepared, water employed preferably includes impurities in an amount as low as possible, and thus water such as ion exchanged water or distilled water is preferred. Furthermore, precision filtration may be carried out to remove contamination, as needed, using a membrane filter or the like. In particular, when the ink is used as an ink for ink jet printers, carrying out the precision filtration is preferred. The filter for carrying out precision filtration has a pore size of usually 1 to 0.1 μm, and preferably 0.8 to 0.1 μm.

The ink composition containing the water-soluble azo compound of the present invention is suited for use in printing, copying, marking, writing, drawing, stamping, or recording (printing), and particularly in ink jet recording. In addition, the ink composition of the present invention is less likely to be deposited as solids even though dried in the vicinity of the nozzle of an ink jet printer, and therefore, clogging of the printer head is also less likely to occur based on the same reason. Moreover, when the ink composition of the present invention is used for ink jet recording, yellow printed matter with a high quality, and very high print density and chroma saturation, having favorable resistance to water, light, ozone, friction and the like can be obtained.

In some ink jet printers, two kinds of inks, i.e., a high concentrarion ink and a low concentrarion ink are loaded in one printer, for the purpose of supplying a high definition image. In this instance, a high concentrarion ink composition and a low concentrarion ink composition are prepared, respectively, using the water-soluble azo compound of the present invention, and these may be used in combination as an ink set. Alternatively, the present compound may be used in either one of them. Furthermore, the water-soluble azo compound of the present invention and a well-known yellow coloring matter may be used in combination. In addition, the water-soluble azo compound of the present invention may be also used for the purpose of color conditioning of other colors, for example, of a black ink, or for preparing a red ink or a green ink by blending with a magenta coloring matter or a cyan coloring matter.

The colored matter of the present invention refers to a substance which was colored with the water-soluble azo compound of the present invention or the ink composition of the present invention containing the compound, or the like.

The material entity of the colored matter is not particularly limited, and any one is acceptable as long as it can be colored, such as for example, a communication sheet such as a paper or film, a fiber or cloth (cellulose, nylon, wool, etc.), a leather, a substrate for color filters, but not limited thereto; however a communication sheet is preferred. The coloring method may include, for example, printing methods such as a dip dyeing method, a textile printing method and a screen printing, as well as ink jet recording methods with an ink jet printer, and the like, but a method by ink jet recording is preferred.

The communication sheet is preferably obtained by subjecting a base material to a surface treatment, and specifically obtained by providing an ink receiving layer on a base material such as paper, synthetic paper, films and the like. The ink receiving layer is provided by, for example: a method in which a cation based polymer is impregnated in or coated on the aforementioned base material; a method in which inorganic fine particles that can absorb a coloring matter in an ink such as porous silica, alumina sol or special ceramics are coated on the surface of the aforementioned base material together with a hydrophilic polymer such as polyvinyl alcohol or polyvinylpyrrolidone.

Such sheets provided with an ink receiving layer are generally referred to as ink jet exclusive paper, ink jet exclusive film, glossy paper, glossy film, and the like.

Among these, paper referred to as being susceptible to gasses having an oxidizing action in the air, i.e., ozone gas, nitrogen oxide gas etc., is ink jet exclusive paper produced by coating the aforementioned porous silica, alumina sol, special ceramics or the like on the surface of a base material.

Examples of typical commercially available product of the ink jet exclusive paper include trade names: Professional Photo Paper, Super Photo Paper, and Glossy Gold manufactured by Canon, Inc.; trade names: Photo Paper CRISPIA (Super Glossy), and Photo Paper (Glossy) manufactured by Seiko Epson Corporation; trade name: Advanced Photo Paper (Glossy) manufactured by Hewlett-Packard Japan, Ltd.; trade name: KASSAI SHASHIN-SHIAGE Pro manufactured by FUJIFILM Corporation; and the like.

Since the ink composition of the present invention is superior in resistance to the gas having an oxidizing action as described above, superior recorded images accompanied by less discoloration and fading can be provided even when recorded on such a type of record-receiving materials. In addition, the composition can be also used for plain paper.

For recording on a record-receiving material with the ink jet recording method of the present invention, for example, a vessel filled with the ink composition is attached at a specified position of an ink jet printer, and the recording may be executed by a conventional method on the record-receiving material. In the ink jet recording method of the present invention, a magenta ink, a cyan ink, as well as if necessary, a green ink, a blue (or violet) ink, a red ink, a black ink and the like may be used in combination with the ink composition of the present invention. In this case, the ink of each color is injected into each vessel, and the vessels are attached at a specified position of the ink jet printer and then used.

There are ink jet printers in which, for example, a piezo system utilizing mechanical vibration; a bubble jet (registered trademark) system utilizing bubbles generated by heating; or the like is adopted. The ink jet recording method of the present invention can be employed according to any system.

The ink composition of the present invention has a brilliant yellow color, provides a high contrast ratio and particularly a high print density of the image recorded particularly on an ink jet exclusive paper or a glossy paper, and has a hue suited for ink jet recording methods. In addition, the ink composition is characterized by having various types of superior fastness of the recorded image such as light resistance, ozone resistance and moisture resistance, and in particular, striking water resistance.

The ink composition of the present invention is precluded from precipitation and separation during storage, thereby capable of providing extremely favorable storage stability. Additionally, when the ink composition of the present invention is used in ink jet recording, deposition of solids due to drying of the ink composition in the vicinity of the nozzle hardly occurs, and clogging of the injector (ink head) can be also avoided. The ink composition of the present invention does not cause alteration of physical properties even in any of the cases in which: the ink is used by recycling with a comparatively long time interval using a continuous ink jet printer; the ink is intermittently used with an on-demand ink jet printer; and the like.

### EXAMPLES

Hereinafter, the present invention is more specifically described by way of Examples. In the specification, the expressions “part” and “%” are on the basis of the mass unless otherwise stated particularly, and the reaction temperature means an interior temperature also unless otherwise stated. Each operation of reaction, crystallization and the like in Examples was carried out under stirring unless otherwise stated particularly.

It should be noted that λmax (wavelength of maximum absorption) of each compound synthesized shows the value of measurement in an aqueous solution of pH 7 to 9. Moreover, although any of the water-soluble azo compound of the present invention obtained in Examples is a sodium salt or an ammonium salt, the chemical structural formula thereof is represented in the form of its free acid for the sake of simplicity. However, alkali metal salts and the like other than the free acids, sodium salts and ammonium salts can be readily obtained using appropriate methods as described above, and the present invention is not limited to the Examples.

### Example 1

### Step 1

4-Aminobenzenesulfonic acid in an amount of 17.3 parts was dissolved in 200 parts of water while adjusting the pH to 6 with sodium hydroxide, and then 7.2 parts of sodium nitrite were added thereto. After this solution was added dropwise to 300 parts of 5% hydrochloric acid at 0 to 10° C. over 30 min, the mixture was stirred at no higher than 10° C. for 1 hour to carry out a diazotization reaction, whereby a diazo reaction liquid was prepared.

On the other hand, 9.3 parts of aniline were dissolved in 130 parts of water while adjusting the pH to 5 with sodium hydroxide and converted into a methyl-ω-sulfonate derivative using 10.4 parts of sodium bisulfite and 8.6 parts of 35% formalin by a routine method.

Thus obtained methyl-ω-sulfonate derivative was added to the diazo reaction liquid prepared beforehand, and the mixture was stirred at 0 to 15° C. and a pH of 2 to 4 for 5 hrs. After the pH of the reaction liquid was adjusted to 11 with sodium hydroxide, the liquid was stirred while maintaining the same pH at 80 to 95° C. for 5 hrs, and further 100 parts of sodium chloride were added thereto to allow for salting-out. The deposited solid was collected by filtration to obtain 100 parts of an azo compound represented by the following formula (10) as wet cake.

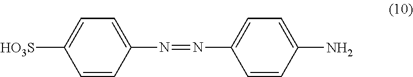

### Step 2

2-Aminonaphthalene-6,8-disulfonic acid in an amount of 30.3 parts was dissolved in 200 parts of water while adjusting the pH to 6 with sodium hydroxide, and then 7.2 parts of sodium nitrite were added thereto. After this solution was added dropwise to 300 parts of 5% hydrochloric acid at 0 to 10° C. over 30 min, the mixture was stirred at no higher than 10° C. for 1 hour to carry out a diazotization reaction, whereby a diazo reaction liquid was prepared.

On the other hand, 23.1 parts of 2-(sulfopropoxy)aniline were dissolved in 130 parts of water while adjusting the pH to 7 with sodium hydroxide and converted into a methyl-ω-sulfonate derivative using 10.4 parts of sodium bisulfite and 8.6 parts of 35% formalin by a routine method.

Thus obtained methyl-ω-sulfonate derivative was added to the diazo reaction liquid prepared beforehand, and the mixture was stirred at 0 to 15° C. and a pH of 2 to 4 for 5 hrs. After the pH of the reaction liquid was adjusted to 11 with sodium hydroxide, the liquid was stirred while maintaining the same pH at 80 to 95° C. for 5 hrs, and further 100 parts of sodium chloride were added thereto to allow for salting-out. The deposited solid was collected by filtration to obtain 150 parts of an azo compound represented by the following formula (11) as wet cake.

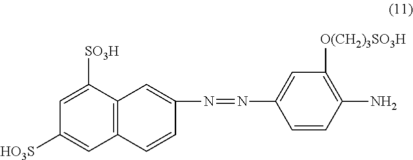

### Step 3

Into 100 parts of ice water were added 0.10 parts of Leocol TD90 (trade name, surfactant) manufactured by Lion Corporation, and the mixture was vigorously stirred, to which 9.2 parts of cyanuric chloride were added, followed by stirring at 0 to 5° C. for 30 min to obtain a suspension.

The wet cake of the compound represented by the formula (10) obtained in the above Step 1 in an amount of 100 parts was dissolved in 200 parts of water, and the aforementioned suspension was added dropwise to this solution over 30 min. After completing the dropwise addition, the mixture was stirred at a pH of 5 to 6 and at 0 to 10° C. for 6 hrs to obtain a reaction liquid.

On the other hand, the wet cake of the compound represented by the formula (11) obtained in the above Step 2 in an amount of 150 parts was dissolved in 300 parts of water, and the solution was added dropwise to the aforementioned reaction liquid over 30 min. After completing the dropwise addition, the mixture was stirred at a pH of 6 to 7 and at 25 to 35° C. for 6 hrs to which 18.8 parts of taurine were added followed by stirring at a pH of 7 to 9 and at 75 to 80° C. for 3 hrs. After cooling the obtained reaction liquid to 20 to 25° C., 800 parts of acetone were added to this reaction liquid, followed by stirring at 20 to 25° C. for 1 hour. The deposited solid was collected by filtration to obtain 95.0 parts of wet cake. This wet cake was dried with a hot-air dryer at 80° C. to obtain 30.0 parts of a sodium salt of the water-soluble azo compound (λmax: 397 nm) of the present invention represented by the following formula (12).

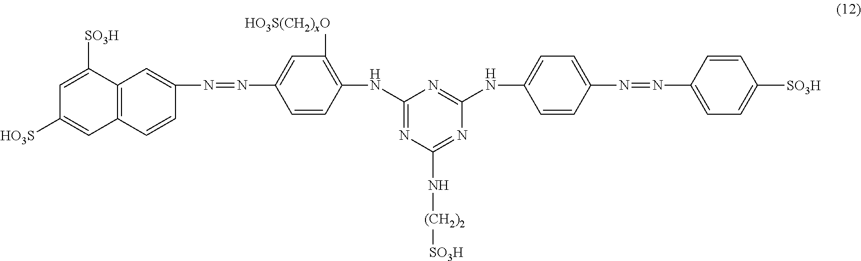

### Example 2

In a similar manner to Example 1 except that 19.7 parts of 6-aminohexanoic acid were used in place of 18.8 parts of taurine used in the Step 3 of Example 1, 30.0 parts of a sodium salt of the water-soluble azo compound (λmax: 386 nm) of the present invention represented by the following formula (13) were obtained.

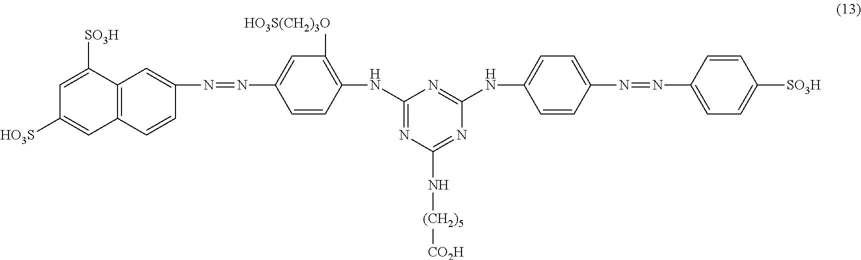

### Example 3

In a similar manner to Example 1 except that 32.3 parts of 12-aminododecanoic acid were used in place of 18.8 parts of taurine used in the Step 3 of Example 1, 28.0 parts of a sodium salt of the water-soluble azo compound (λmax: 393 nm) of the present invention represented by the following formula (14) were obtained.

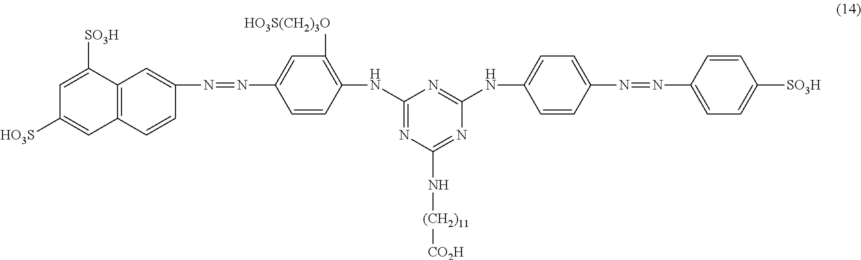

### Example 4

In a similar manner to Example 1 except that 34.6 parts of 3-aminobenzenesulfonic acid were used in place of 18.8 parts of taurine used in the Step 3 of Example 1, 15.0 parts of a sodium salt of the water-soluble azo compound (λmax: 387 nm) of the present invention represented by the following formula (15) were obtained.

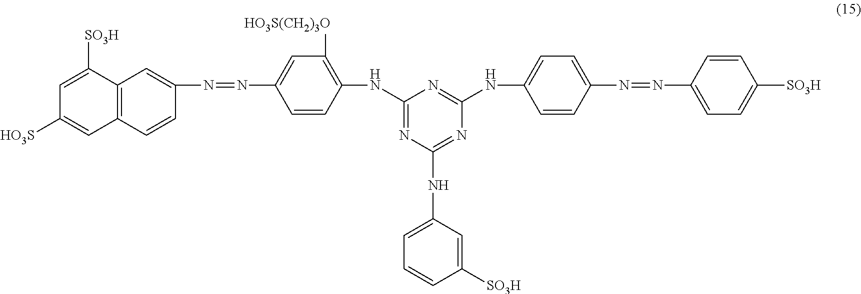

### Example 5

In a similar manner to Example 1 except that 27.4 parts of 3-aminobenzoic acid were used in place of 18.8 parts of taurine used in the Step 3 of Example 1, 12.0 parts of a sodium salt of the water-soluble azo compound (λmax: 390 nm) of the present invention represented by the following formula (16) were obtained.

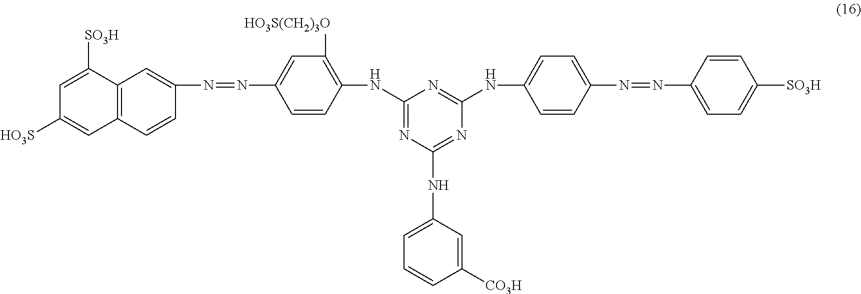

### Example 6

In a similar manner to Example 1 except that 28.1 parts of 4-(aminomethyl)benzenesulfonic acid were used in place of 18.8 parts of taurine used in the Step 3 of Example 1, 29.0 parts of a sodium salt of the water-soluble azo compound (λmax: 390 nm) of the present invention represented by the following formula (17) were obtained.

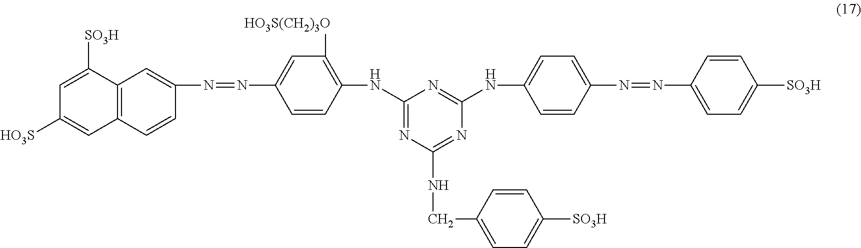

### Example 7

In a similar manner to Example 1 except that 29.4 parts of glutamic acid were used in place of 18.8 parts of taurine used in the Step 3 of Example 1, 22.5 parts of a sodium salt of the water-soluble azo compound (λmax: 395 nm) of the present invention represented by the following formula (18) were obtained.

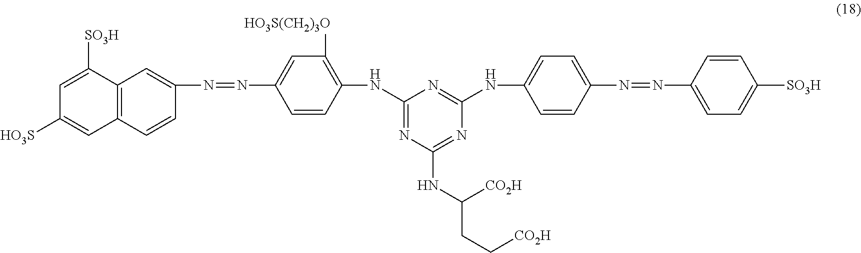

### Example 8

In a similar manner to Example 1 except that 9.5 parts of phenylalanine were used in place of 18.8 parts of taurine used in the Step 3 of Example 1, 28.0 parts of a sodium salt of the water-soluble azo compound (λmax: 394 nm) of the present invention represented by the following formula (19) were obtained.

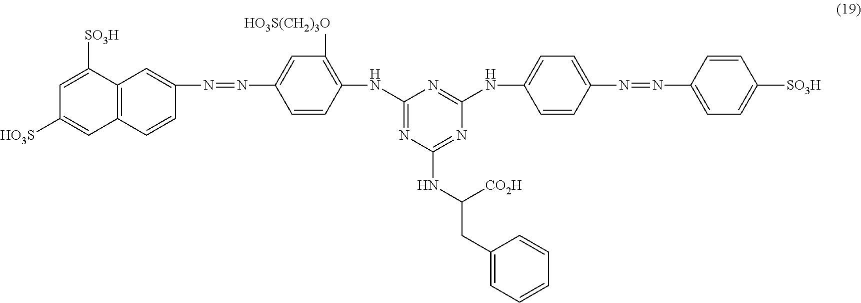

### Example 9

The sodium salt of the water-soluble azo compound of the present invention represented by the above formula (13) obtained in Example 2 in an amount of 30.0 parts was dissolved in 270 parts of water, and thereto were added 45 parts of ammonium chloride. The pH of this solution was adjusted to be 1 to 6 with hydrochloric acid, and the mixture was stirred for 30 min, followed by collecting the deposited solid by filtration. Accordingly, a salt exchange reaction from the sodium salt to an ammonium salt was executed, whereby 110 parts of a wet cake were obtained. After this wet cake was washed with 200 parts of methanol, drying with a hot-air dryer at 80° C. gave 24.0 parts of an ammonium salt of the water-soluble azo compound (λmax: 391 nm) of the present invention represented by the above formula (13).

### Example 10

The sodium salt of the water-soluble azo compound of the present invention represented by the above formula (16) obtained in Example 5 in an amount of 12.0 parts was dissolved in 100 parts of water, and thereto were added 25 parts of ammonium chloride. The pH of this solution was adjusted to be 1 to 6 with hydrochloric acid, and the mixture was stirred for 30 min, followed by collecting the deposited solid by filtration. Accordingly, a salt exchange reaction from the sodium salt to an ammonium salt was executed, whereby 40 parts of a wet cake were obtained. After this wet cake was washed with 200 parts of methanol, drying with a hot-air dryer at 80° C. gave 10.0 parts of an ammonium salt of the water-soluble azo compound (λmax: 386 nm) of the present invention represented by the above formula (16).

### Example 11

The sodium salt of the water-soluble azo compound of the present invention represented by the above formula (18) obtained in Example 7 in an amount of 22.5 parts was dissolved in 270 parts of water, and thereto were added 45 parts of ammonium chloride. The pH of this solution was adjusted to be 1 to 6 with hydrochloric acid, and the mixture was stirred for 30 min, followed by collecting the deposited solid by filtration. Accordingly, a salt exchange reaction from the sodium salt to an ammonium salt was executed, whereby 80 parts of a wet cake were obtained. After this wet cake was washed with 200 parts of methanol, drying with a hot-air dryer at 80° C. gave 20.0 parts of an ammonium salt of the water-soluble azo compound (λmax: 393 nm) of the present invention represented by the above formula (18).

### Example 12

The sodium salt of the water-soluble azo compound of the present invention represented by the above formula (19) obtained in Example 8 in an amount of 28.0 parts was dissolved in 270 parts of water, and thereto were added 45 parts of ammonium chloride. The pH of this solution was adjusted to be 1 to 6 with hydrochloric acid, and the mixture was stirred for 30 min, followed by collecting the deposited solid by filtration. Accordingly, a salt exchange reaction from the sodium salt to an ammonium salt was executed, whereby 90 parts of a wet cake were obtained. After this wet cake was washed with 200 parts of methanol, drying with a hot-air dryer at 80° C. gave 24.0 parts of an ammonium salt of the water-soluble azo compound (λₘₐₓ: 389 nm) of the present invention represented by the above formula (19).

### Examples 13 to 21

### (A) Preparation of Ink

Using the azo compound of the present invention obtained in each of the aforementioned Examples as a coloring matter, components were mixed with the composition ratio shown in the following Table 2 to obtain the ink composition of the present invention, which was each filtered through a 0.45 μm membrane filter to remove contaminants, whereby an ink for tests was prepared. In this process, for providing the ink composition having a pH of 7 to 9, the pH was adjusted using an aqueous sodium hydroxide solution when the coloring matter was the sodium salt, whereas the pH was adjusted using aqueous ammonia when the coloring matter was the ammonium salt. It is to be noted that any water employed for preparing the ink was ion exchanged water, and water was added to give the total volume of 100 parts. Preparation of the ink using the compound of Example 1 is designated as Example 13, and similarly, preparations of the inks using the compounds of Examples 2, 4, 5, 6, 7, 9, 10 and 12 are designated as Examples 14 to 21, respectively.

TABLE 2
Composition Ratio of Ink Composition

| | | |
|---|---|---|
| Azo compound obtained in above each Example | 3.5 | parts |
| glycerin | 5.0 | parts |
| urea | 5.0 | parts |
| N-methyl-2-pyrrolidone | 4.0 | parts |
| isopropyl alcohol | 3.0 | parts |
| butylcarbitol | 2.0 | parts |
| trade name Surfynol 104PG50 (Note) | 0.1 | parts |
| sodium hydroxide or aqueous ammonia + water | 77.4 | parts |
| Total | 100.0 | parts |

(Note)
Acetylene glycol based nonionic surfactant, manufactured by Nissin Chemical Co., Ltd.

### Comparative Example 1

Comparative ink was prepared in a similar manner to Example 13 except that a compound represented by the following formula (20) synthesized by a method disclosed in Example 1 of Patent Document 1 was used in place of the water-soluble azo compound of the present invention. This preparation was designated as Comparative Example 1. It is to be noted that the evaluation tests were performed using the sodium salt of the compound represented by the following formula (20).

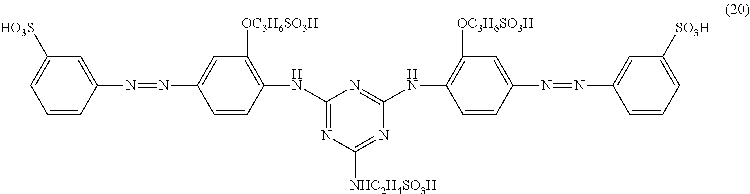

### Comparative Example 2

Comparative ink was prepared in a similar manner to Example 13 except that a compound represented by the following formula (21) synthesized by a method disclosed in Example 1 of Patent Document 2 was used in place of the water-soluble azo compound of the present invention. This preparation was designated as Comparative Example 2. It is to be noted that the evaluation tests were performed using the sodium salt of the compound represented by the following formula (21).

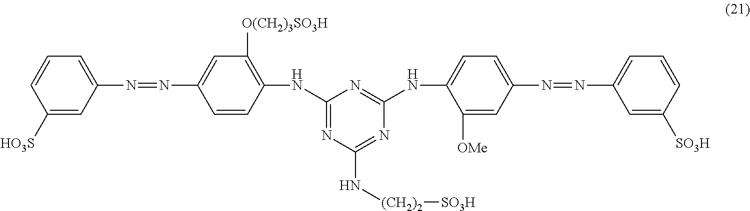

### Comparative Example 3

Comparative ink was prepared in a similar manner to Example 13 except that a compound represented by the following formula (22) synthesized by a method disclosed in Patent Document 3 was used in place of the water-soluble azo compound of the present invention. This preparation was designated as Comparative Example 3. It is to be noted that the evaluation tests were performed using the sodium salt of the compound represented by the following formula (22).

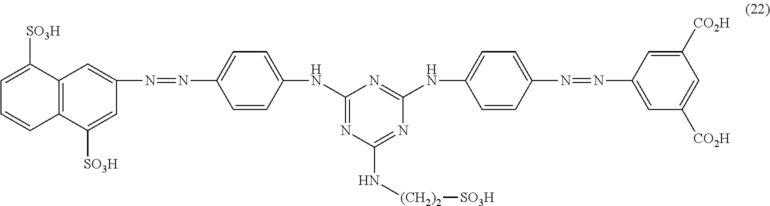

### (B) Ink Jet Recording

Using an ink jet printer (manufactured by Canon, Inc., trade name: PIXUS ip4100), ink jet recording was carried out on an exclusive ink jet paper (manufactured by Hewlett-Packard Japan, Ltd., trade name: Advanced Photo Paper (Glossy)). Upon ink jet recording, an image pattern was produced such that several-step gradation of the reflected density was obtained, whereby a yellow printed matter was produced. Using thus obtained printed matter as a test piece, various types of tests were performed.

For the light resistance test and the ozone gas resistance test, reflected density was determined on a part where the reflected density, i.e., D value, of the printed matter before the test was most approximate to 1.0. In addition, the reflected density was colorimetrically determined using a colorimetric system (Sectro Eye, manufactured by Gretag Macbeth Co.). The colorimetric determination was carried out under a condition of a viewing angle of 2°, and a light source of D65, with a density standard of ANSI A.

Various test methods, and evaluation methods of the test results of the recorded image are described below.

### (C) Chroma Saturation of Printed Matter

With respect to a part having the highest reflected density in the image printed on the glossy paper, values of the chromaticity (a* and b*) were colorimetrically measured using the aforementioned colorimetric system, whereby a chroma saturation C* was determined according to the following formula. The chroma saturation of a higher value is more preferred as superior brilliant is suggested.

C*[(a*)²+(b*)²]^{1/2}

The results are shown in Table 3 below.

### (D) Print Density of Printed Matter

With respect to a part having the highest reflected density in the image recorded on the glossy paper, the value of yellow density Dy was measured using the aforementioned colorimetric system. A greater density value Dy is more preferred.

The results are shown in Table 3 below.

### (E) Xenon Light Resistance Test

The test piece obtained by the aforementioned method was put into a holder, and irradiated at an illuminance of 0.36 W/m², at a temperature of 24° C., and a humidity of 60% RH using a Xenon Weather Meter XL75 (manufactured by Suga Test Instruments Co., Ltd.) for 72 hrs.

After the testing, the reflected density was colorimetrically determined using the aforementioned colorimetric system. After the measurement, the residual ratio of the coloring matter was determined by calculation according to the formula of: (reflected density after test/reflected density before test)×100(%), and evaluation was made by rating on a two point scale.

Residual ratio of the coloring matter being no less than 85%: A

Residual ratio of the coloring matter being less than 85%: C

The results are shown in Table 3 below.

### (F) Ozone Gas Resistance Test

After the test piece obtained as described above was left to stand under a condition of: an ozone concentration of 40 ppm; a humidity of 60% RH; and a temperature of 24° C., using an Ozone Weather Meter (manufactured by Suga Test Instruments Co., Ltd.) for 16 hrs, the reflected density was colorimetrically determined using the aforementioned colorimetric system. After the measurement, the residual ratio of the coloring matter was determined by calculation according to the formula of: (reflected density after test/reflected density before test)×100(%), and evaluation was made by rating on a two point scale.

Residual ratio of the coloring matter being no less than 80%: A

Residual ratio of the coloring matter being less than 80%: C

The results are shown in Table 3 below.

### (G) Storage Stability Test of Ink

With respect to each ink prepared in Examples 13 to 21, and Comparative Examples 1 to 3, storage stability was ascertained by storing in a closed and sealed vessel at room temperatures (18 to 28° C.) for one month. The evaluation was made by visual inspection, and evaluated based on the following criteria.

Neither precipitation nor gelation found after storage for one month: A

Precipitation generated or the ink gelated after storage for one month: C

The results are shown in Table 3 below.

TABLE 3
Test results (C) to (G)

| | (C) | (D) | (E) | (F) | (G) |
|---|---|---|---|---|---|
| Example 13 | 112 | 1.93 | A | A | A |
| Example 14 | 111 | 1.94 | A | A | A |
| Example 15 | 114 | 2.02 | A | A | A |
| Example 16 | 109 | 1.91 | A | A | A |
| Example 17 | 112 | 1.95 | A | A | A |
| Example 18 | 108 | 1.91 | A | A | A |
| Example 19 | 109 | 2.00 | A | A | A |
| Example 20 | 110 | 1.94 | A | A | A |
| Example 21 | 108 | 1.93 | A | A | A |
| Comparative Example 1 | 100 | 1.71 | A | C | A |
| Comparative Example 2 | 105 | 1.79 | A | C | A |
| Comparative Example 3 | 94 | 1.62 | A | A | A |

### (H) Moisture Resistance Test

The test piece produced by printing on the glossy paper was left to stand at 30° C. and at 80% RH using a constant temperature and humidity chamber IG400 (manufactured by Yamato Scientific Co., Ltd.) for 5 days, and bleeding from the printed part to the unprinted part was visually assessed by comparing before and after performing the test. Evaluation criteria are as in the following.

Bleeding of the coloring matter to the unprinted part hardly found: A

Bleeding of the coloring matter to the unprinted part somewhat found: B

Bleeding of the coloring matter to the unprinted part considerably found: C

The results are shown in Table 4 below.

### (I) Water Resistance Test

Onto the test piece produced by printing on the glossy paper was placed one drop of ion exchanged water on the printed surface 30 min after the printing. The water droplet was evaporated by drying as is for one day, and the extent of bleeding from the printed part to the unprinted part was visually assessed by comparing before and after performing the test. Evaluation criteria are as in the following.

The extent of bleeding to the unprinted part being similar to Comparative Example 2: A

The extent of bleeding to the unprinted part indicating inferior results as compared with Comparative Example 2: C

The results are shown in Table 4 below.

### (J) Water Resistance Test

Onto the test piece produced by printing with a method being similar to the aforementioned printing method except that the printed medium was changed from the glossy paper to a plain paper, was placed one drop of ion exchanged water on the printed surface 30 min after the printing. The water droplet was evaporated by drying as is for one day, and the extent of bleeding from the printed part to the unprinted part was visually assessed by comparing before and after performing the test. Evaluation criteria are as in the following.

The extent of bleeding to the unprinted part indicating superior results as compared with Comparative Example 2: S

The extent of bleeding to the unprinted part being similar to Comparative Example 2: A

The extent of bleeding to the unprinted part indicating inferior results as compared with Comparative Example 2: C

The results are shown in Table 4 below.

TABLE 4
Various types of test results (H) to (J)

| | (H) | (I) | (J) |
|---|---|---|---|
| Example 13 | A | A | A |
| Example 14 | A | A | S |
| Example 15 | A | A | S |
| Example 16 | A | A | S |
| Example 17 | A | A | S |
| Example 18 | A | A | A |
| Example 19 | A | A | S |
| Example 20 | A | A | S |
| Example 21 | A | A | S |
| Comparative Example 1 | A | A | C |
| Comparative Example 2 | A | A | — |
| Comparative Example 3 | A | A | S |

As is clear from the results shown in Tables 3 and 4, although Comparative examples 1 and 2 resulted in superior light resistance, they attained smaller values in connection with the chroma saturation (C) and the print density (D) as compared with other examples. Also, the coloring matter residual ratio after performing the test was less than 80% in the ozone gas resistance test (F), and thus it was reveled that there were problems in the chroma saturation (C), the print density (D), and the ozone gas resistance (F).

Additionally, Comparative Example 3 showed superior results to Comparative Examples 1 and 2 with respect to the ozone gas resistance (F); however, the smallest values of the chroma saturation (C) and the print density (D) among the tested examples were found, revealing Comparative Example 3 to be unsatisfactory in these regards.

To the contrary, the printed matter of each Example indicated performances that are comparative to or better than those of Comparative Examples in connection with the xenon light resistance test (E) and ozone gas resistance (F) test. Still further, each Example indicated that the chroma saturation (C) tends to be greater than each Comparative Example, and resulted in a very large value of the print density (D), i.e., no less than 1.91. Accordingly, each Example was proven to be more excellent than each Comparative Example. In addition, when a glossy paper was used, each Example and each Comparative Example resulted in a similar level of water resistance, indicating favorable results in both cases. To the contrary, according to the water resistance test (J) performed using a plain paper, each Example was proven to result in significantly superior water resistance than Comparative Examples 1 and 2.

From the foregoing results, the water-soluble azo compound of the present invention is revealed to be a coloring matter being: suited for preparing an ink for ink jet recording; extremely excellent in various types of fastness properties, such as light resistance, ozone gas resistance etc.; and stable in that precipitation or gelation does not occur even if stored for a long period of time, and also having a high print density and aroma saturation as a yellow coloring matter. Moreover, the resistance to water was also excellent, and from these features, it is concluded that the azo compound of the present invention is a compound which is very useful as a variety of ink coloring matters for recording, particularly as yellow coloring matters for ink jet inks.

1. A water-soluble azo compound represented by the following formula (1) or a salt thereof 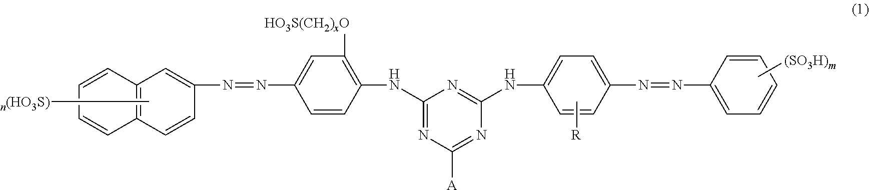
wherein,
R represents a hydrogen atom, a C1-C4 alkyl group, or a C1-C4 alkoxy group;
n represents an integer of 1 to 3, m represents an integer of 1 or 2, and x represents an integer of 2 to 4;
group A represents a substituted or unsubstituted C1-C20 aliphatic amino group, a hydroxy substituted mono- or di-C1-C4 aliphatic amino group, a mono- or di-carboxy substituted C1-C20 aliphatic amino group, a sulfo substituted C1-C3 aliphatic amino group, a substituted or unsubstituted 5- or 6-membered nitrogen-containing heterocyclic group, a substituted or unsubstituted aromatic amino group, or a substituted or unsubstituted aryl C1-C4 alkylamino group.

2. The water-soluble azo compound or a salt thereof according to claim 1, wherein: the water-soluble azo compound represented by the formula (1) or a salt thereof is a water-soluble azo compound represented by the following formula (2) or a salt thereof, 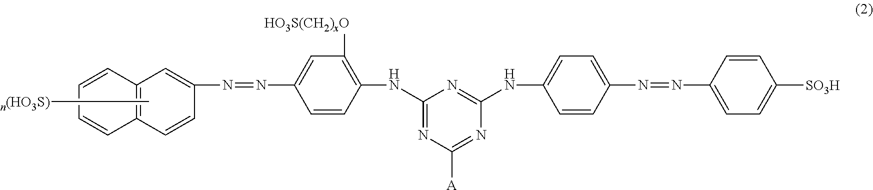
wherein, n, x, and group A are as defined in the formula (1).

3. The water-soluble azo compound or a salt thereof according to claim 1, wherein: the group A is selected from the group consisting of amino groups represented by the following formulae (3) to (8), 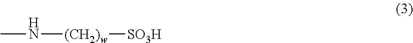
wherein, w represents an integer of 1 to 3; 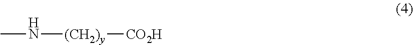
wherein, y represents an integer of 1 to 11; 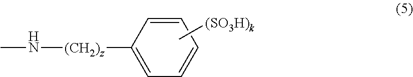
wherein, z represents an integer of 1 to 3, and k represents an integer of 0 to 2; 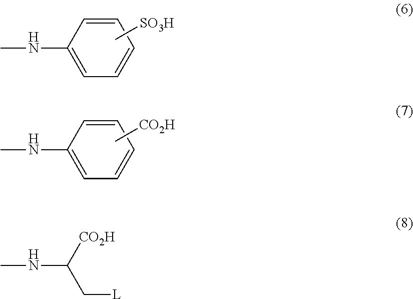
wherein, group L represents a phenyl group or a carboxymethyl group.

4. The water-soluble azo compound or a salt thereof according to claim 1, wherein: n is 2; x is 3; and the group A is an amino group represented by the formula (7).

5. An ink composition comprising the water-soluble azo compound or a salt thereof according to claim 1 as a coloring matter.

6. The ink composition according to claim 5 further comprising a water-soluble organic solvent.

7. The ink composition according to claim 5 which is for use in ink jet recording.

8. An ink jet recording method comprising: discharging ink droplets in response to recording signals using the ink composition according to claim 5 as an ink to allow the droplets to adhere onto a record-receiving material thereby executing recording.

9. The ink jet recording method according to claim 8, wherein the record-receiving material is a communication sheet.

10. The ink jet recording method according to claim 9, wherein the communication sheet is a sheet having an ink receiving layer containing a porous white inorganic substance.

11. A colored matter which is colored with the water-soluble azo compound or a salt thereof according to claim 1.

12. The colored matter according to claim 11, wherein the coloring is carried out with an ink jet printer.

13. An ink jet printer equipped with a vessel containing the ink composition according to claim.

14. A colored matter which is colored with the ink composition according to claim 5.
